(19) United States
(12) Patent Application Publication
(10) Pub. No.: US 2007/0093957 A1
(43) Pub. Date: Apr. 26, 2007

(54) IMAGE DATA TRANSMITTING/RECEIVING SYSTEM, SERVER, MOBILE PHONE TERMINAL,PROGRAM AND RECORDING MEDIUM

(76) Inventors: Shin Kikuchi, Tokyo (JP); Keisuke Onishi, Tokyo (JP); Yusuke Suzuki, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 10/576,871

(22) PCT Filed: Oct. 21, 2004
(86) PCT No.: PCT/JP04/15637

§ 371 Date: Apr. 21, 2006

(30) Foreign Application Priority Data
Oct. 23, 2003 (JP) 2003-363819

(51) Int. Cl. G01C 21/32

(52) U.S. Cl. 701/208; 340/995.1

(57) ABSTRACT

An image data transmitting/receiving system for displaying an image having an optimum size in accordance with the resolution of an information display screen (11) of a mobile terminal (1), comprising the mobile terminal (1) and a server (7). The mobile terminal (1) comprises terminal-side symbol image data storing means (KC2) for storing data of symbol image used for producing a displayed image; and symbol image data transmission request information transmitting means (KC10B) for transmitting information related to the resolution of the information display screen (11) to the server (7). The server (7) comprises server-side symbol image data storing means (SC2A) for storing a plurality of symbol image data in accordance with the resolution of the information display screen (11); terminal resolution determining means (SC3) for determining, based on the received resolution related information, the symbol image data to be transmitted to the mobile terminal (1); and symbol image data transmitting means (SC5B) for transmitting the symbol image data in accordance with the aforementioned resolution.

### FIELD OF THE INVENTION

The present invention relates to a portable and convenient to use mobile phone, a mobile terminal such as a PDA, a server that can transmit to and receive image data from the mobile terminal through a line, an image data transmitting/receiving system including the mobile terminal and the server, a program for activating a computer included in the mobile terminal or the server to function, and a recording medium for recording the program. Specifically, the invention relates to an image data transmitting/receiving system that can transmit/receive and/or display symbol image data which are used in creating display images partly constituting specific graphic symbols such as map symbol images and icons, etc. to be arranged on an information display screen of the mobile terminal, a mobile phone and a server that are used in the image data transmitting/receiving system, a program for activating a computer included in the mobile terminal or the server to function, and a recording medium for recording the program.

### BACKGROUND OF THE INVENTION

In recent years, mobile terminals such as mobile phones have functioned to display map images in correspondence with users' inputs, as well as a navigating tool using map images.

Japanese Patent Publication No. JP-2001-5763-A (paragraph [0029]-[0035], FIG. 5, hereinafter, “Patent Document 1”) discloses a technique that allows the display of map images on a display screen of a mobile terminal, where a mobile phone having a small information-display screen creates map images arranged on the information-display screen and displays roads and railways, etc., on the map images with the aid of lines formed along the central portion of the map images, and displays land marks such as multistoried buildings and so forth with the aid of icons (symbol images) representing different types of attributes, making it convenient for a user to view.

The resolution of the information display screen of mobile terminals has been enhanced in recent years, accompanied by technological progress in the development of image display devices. In particular, while conventional mobile phones have a resolution of about 170 dots by 120 dots, recent mobile phones already possess a resolution of the QVGA (320 dots by 240 dots). It is expected that resolution of mobile phones will improve even further in the near future.

However, since the total size of mobile terminals such as mobile phones is substantially fixed, and the outer dimensions of the information display screen cannot be expanded in contrast to the conventional type, the dot pitch (interval between dots) has become narrower to enhance resolution of the information display screen.

Of course, resolution enhancement favorably brings about finer display of images. Where a symbol image is created with a specific dot number (12 dots by 12 dots, for example), the symbol image can be displayed to have an appropriate size on a low-resolution display screen. However, the symbol image becomes too small for users to view on a high-resolution display screen because of the narrow dot pitch.

In the technique disclosed in Patent Document 1, the server connected to various mobile terminals having information display devices of varying resolution capabilities lays out symbol images of a specific dot number to create map images. Therefore, the technique does not deal with the problem of large map images being transmitted from the server for display on the mobile terminals, such that viewing thereof becomes difficult when actually displayed on a high-resolution mobile terminal.

### SUMMARY OF THE INVENTION

Considering the aforementioned problems, the inventors have sought to create the present invention which provides for a technique for displaying images to optimum size, in accordance with the resolution capability of information image display screens of mobile terminals.

Description of the present invention that addresses the aforementioned problems follows hereafter, in which the components of the invention are ascribed certain symbols enclosed in parentheses. Symbols which are not marked with parentheses will also be ascribed to components of concrete examples of the preferred embodiments (to be described later) in order to distinguish components of the invention from components of the concrete examples. The present invention will be described in relation to the symbols of the components in the concrete examples merely for the purpose of facilitating understanding of the invention and are not intended to restrict the scope of the invention to such examples.

First Invention

The first invention seeks to address the aforementioned problems by providing for an image data transmitting/receiving system (S) which comprises a mobile terminal (1) provided with components (A1) through (A5) and a server (7) provided with components (B1) through (B4), as follows:

(A1), an information display screen (11) on which information is displayed,

(A2), a resolution related information storage means (KC1) that stores resolution related information pertinent to the resolution of the information display screen (11),

(A3), a terminal-side symbol image data storage means (KC2) that stores symbol image data which are used in creating display images partly constituting specific graphic symbols and which are arranged on the information display screen (11),

(A4), a symbol image data transmission request information transmitting means (KC10B) that transmits symbol image data transmission requests for the transmission of symbol image data stored in the server (7) and the resolution related information to the server (7),

(A5), a symbol image data receiving means (KC11B) that receives the symbol image data transmitted from the server (7),

(B1), a server-side symbol image data storage means (SC2A) that stores the symbol image data in correspondence with the resolution of the information display screen (11) of the mobile terminal (1),

(B2), a symbol image data transmission request information receiving means (SC1B) that receives the symbol image data transmission request information and the resolution related information, which are transmitted from the mobile terminal (1),

(B3), a terminal resolution discrimination means (SC3) that discriminates the symbol image data transmitted to the mobile terminal (1) on the basis of the resolution related information received, and

(B4), a symbol image data transmitting means (SC5B) that transmits the symbol image data which is discriminated by the terminal resolution discrimination means (SC3) in correspondence with the resolution of the information display screen (11) of the mobile terminal (1).

Function of the First Invention

In the image data transmitting/receiving system (S) of the first invention comprising the mobile terminal (1) provided with the above-mentioned components (A1) through (A5) and the server (7) provided with the above-mentioned components (B1) through (B4), the resolution related information pertinent to the resolution of the information display screen (11) for displaying information is stored in the resolution related information storage means (KC1) of the mobile terminal (1), while symbol image data, which are used in creating display images arranged on the information display screen (11), which presents symbol images constituting specific graphic symbols forming part of the display images, are stored in the terminal-side symbol image data storage means (KC2) of the mobile terminal (1). The symbol image data transmission request information transmitting means (KC10B) of the mobile terminal (1) transmits symbol image data transmission requests for the server (7) to transmit the symbol image data stored in the server (7), and the resolution related information.

The symbol image data transmission request information receiving means (SC1B) of the server (7) receives the symbol image data transmission request information and the resolution related information which are transmitted from the mobile terminal (1). The terminal resolution discrimination means (SC3) of the server (7) discriminates the symbol image data transmitted to the mobile terminal (1) on the basis of the received resolution related information from a plurality of symbol image data in correspondence with the resolution of the information display screen (11) of the mobile terminal (1), which are stored in the server-side symbol image data storage means (SC2A). And, the symbol image data transmitting means (SC5B) transmits symbol image data in correspondence with the resolution of the information display screen (11) of the mobile terminal (1), which is discriminated by the terminal resolution discrimination means (SC3).

The symbol image data transmitted from the server (7) are received by the symbol image data receiving means (KC11B) of the mobile terminal (1), which are stored in the terminal-side symbol image data storage means (KC2).

Accordingly, in the image data transmitting/receiving system (S) of the first invention, the symbol image data corresponding to the resolution of the information display screen (11) are stored in the terminal-side symbol image data storage means (KC2) of the mobile terminal (1). In other words, when the created display images are arranged on the information display screen (11), the symbol image data corresponding to the resolution of the information display screen (11) are used. As a result, display images of appropriate sizes in correspondence with the resolution of the information display screen (11) can be displayed. Therefore, where the information display screen (11) has high resolution capability, the problem of symbol images becoming excessively small for easy viewing can be solved. Conversely, where the information display screen (11) has low resolution capability, the problem of symbol images becoming excessively large and the display images (map images, for example) becoming difficult to view can be avoided.

### Embodiment 1 of the First Invention

In embodiment 1 of the first invention, the image data transmitting/receiving system (S) comprises the mobile terminal (1) provided with components (A6) through (A10) and the server (7) provided with components (B5) through (B7), as follows:

(A6), a terminal-side image data identification information storage means (KC3) that stores the terminal-side image data identification information constituting identification information of the symbol image data stored in the terminal-side symbol image data storage means (KC2),

(A7), an identification information transmission request information transmitting means (KC10A) that transmits server-side image data identification information transmission requests for the server (7) to transmit server-side image data identification information constituting identification information of the symbol image data stored in the server (7), before creating images displayed on the information display screen (11),

(A8), a server-side image data identification information receiving means (KC11A) that receives the server-side image data identification information transmitted from the server (7),

(A9), a latest symbol image data discrimination means (KC4) that discriminates whether the symbol image data stored in the mobile terminal (1) are the latest data, on the basis of the server-side image data identification information and the terminal-side image data identification information received,

(A10) the symbol image data transmission request information transmitting means (KC10B) that transmits the symbol image data transmission requests and the resolution related information to the server (7), when the symbol image data stored in the mobile terminal (1) are determined as not being the latest data.

(B5), a server-side image data identification information storage means (SC2B) that stores the server-side image data identification information constituting identification information of the symbol image data stored in the server-side symbol image data storage means (SC2A),

(B6), a server-side image data identification information transmission request information receiving means (SC1A) that receives the server-side image data identification information transmission requests transmitted from the mobile terminal (1), and

(B7), a server-side image data identification information transmitting means (SC5A) that transmits the server-side image data identification information upon receiving the server-side image data identification information transmission request.

Function of Embodiment 1 of the First Invention

The image data transmitting/receiving system (S) of embodiment 1 of the first invention comprising the mobile terminal (1) provided with components (A6) through (A10) and the server (7) provided with components (B5) through (B7), the terminal-side image data identification information storage means (KC3) of the mobile terminal (1) stores the terminal-side image data identification information constituting the identification information corresponding to the symbol image data stored in the terminal-side symbol image data storage means (KC2). The identification information transmission request information transmitting means (KC10A) transmits the server-side image data identification information transmission request for the server (7) to transmit the server-side image data identification information constituting the identification information of the symbol image data stored in the server (7), before creating images displayed on the information display screen (11).

The server-side image data identification information transmission request transmitted from the mobile terminal (1) is received by the server-side image data identification information transmission request information receiving means (SC1A) of the server (7). The server (7) includes the server-side image data identification information storage means (SC2B) that stores the server-side image data identification information constituting the identification information of the symbol image data stored in the server-side symbol image data storage means (SC2A). And, the server-side image data identification information transmitting means (SC5A) transmits the server-side image data identification information in the process of receiving the server-side image data identification information transmission request.

The server-side image data identification information transmitted from the server (7) is received by the server-side image data identification information receiving means (KC11A). The latest symbol image data discrimination means (KC4) discriminates whether the symbol image data stored in the mobile terminal (1) are the latest data, on the basis of the server-side image data identification information and the terminal-side image data identification information received. And, when the symbol image data stored in the mobile terminal (1) are determined as not being the latest data, the symbol image data transmission request information transmitting means (KC10B) transmits the symbol image data transmission request and the resolution related information to the server (7).

Therefore, in the image data transmitting/receiving system (S) of embodiment 1 of the first invention, the latest symbol image data discrimination means (KC4) of the mobile terminal (1) discriminates whether the symbol image data stored in the terminal-side symbol image data storage means (KC2) of the mobile terminal (1) are the latest data. It is only when the symbol image data in the mobile terminal (1) is determined not to be the latest by way of up-dating the symbol image data stored in the server-side symbol image data storage means (SC2A) and so forth, that the symbol image data are transmitted from the server (7) to the mobile terminal (1). As a result, in contrast to the case where the symbol image data is transmitted every time without a determination being made that it is the latest, the image data transmitting/receiving system (S) of embodiment 1 of the first invention succeeds in effecting reduction of the quantity of data transmitted and received, and reduction of communication cost, while preventing communication jams. Further, since the mobile terminal (1) discriminates whether the symbol image data are the latest data, the load on the server (7) can be reduced.

### Embodiment 2 of the First Invention

The image data transmitting/receiving system (S) of embodiment 2 of the first invention comprises the image data transmitting/receiving system (S) of the first invention, the mobile terminal (1) provided with components (A6), (A11), and (A12), and the server (7) provided with components (B5), and (B8) through (B11), as follows:

(A6), a terminal-side image data identification information storage means (KC3) that stores terminal-side image data identification information constituting identification information of the symbol image data stored in the terminal-side symbol image data storage means (KC2), (A11), the symbol image data transmission request information transmitting means (KC10B) that transmits the symbol image data transmission requests, the resolution related information, and the terminal-side image data identification information to the server (7) before creating images displayed on the information display screen (11),

(A12), a latest data notice information receiving means (KC11D) that receives notice of information on the latest data indicating that the symbol image data stored in the terminal-side symbol image data storage means (KC2) are the latest data,

(B5), a server-side image data identification information storage means (SC2B) that stores server-side image data identification information constituting identification information of the symbol image data stored in the server-side symbol image data storage means (SC2A),

(B8), the symbol image data transmission request information receiving means (SC1B) that receives the symbol image data transmission requests, the resolution related information, and the terminal-side image data identification information, which are transmitted from the mobile terminal (1),

(B9), a latest symbol image data discrimination means (SC6) that discriminates whether the symbol image data stored in the mobile terminal (1) are the latest data, on the basis of the terminal-side image data identification information and the server-side image data identification information received,

(B10), a latest data notice information transmitting means (SC5D) that transmits the notice of information on the latest data and does not transmit the symbol image data stored in the server (7) to the mobile terminal (1) when it is determined that the symbol image data stored in the mobile terminal (1) are the latest data,

(B11), the terminal resolution discrimination means (SC3) that discriminates the symbol image data transmitted to the mobile terminal (1) on the basis of the resolution related information received, when the symbol image data stored in the mobile terminal (1) is determined as not being the latest data.

Function of Embodiment 2 of the First Invention

In the image data transmitting/receiving system (S) of embodiment 2 of the first invention comprising the mobile terminal (1) provided with components (A6), (A11), and (A12), and the server (7) provided with components (B5), and (B8) through (B11), the terminal-side image data identification information storage means (KC3) of the mobile terminal (1) stores the terminal-side image data identification information constituting the identification information of the symbol image data stored in the terminal-side symbol image data storage means (KC2). The symbol image data transmission request information transmitting means (KC10B) transmits the symbol image data transmission request, the resolution related information, and the terminal-side image data identification information to the server (7), before creating images displayed on the information display screen (11).

The symbol image data transmission request, the resolution related information, and the terminal-side image data identification information transmitted from the mobile terminal (1), are received by the symbol image data transmission request information receiving means (SC1B) of the server (7). The server-side image data identification information constituting the identification information of the symbol image data stored in the server-side symbol image data storage means (SC2A) are stored in the server-side image data identification information storage means (SC2B) of the server (7). The latest symbol image data discrimination means (SC6) of the server (7) discriminates whether the symbol image data stored in the mobile terminal (1) are the latest data on the basis of the terminal-side image data identification information and the server-side image data identification information received.

When the symbol image data stored in the mobile terminal (1) are determined as being the latest data, the latest data notice information transmitting means (SC5D) of the server (7) transmits such latest data notice information and does not transmit the symbol image data stored in the server (7) to the mobile terminal (1). And, the latest data notice information receiving means (KC11D) of the terminal (1) receives the latest data notice information indicating that the symbol image data stored in the terminal-side symbol image data storage means (KC2) are the latest.

On the other hand, when the symbol image data stored in the mobile terminal (1) are determined as not being the latest data, the terminal resolution discrimination means (SC3) discriminates the symbol image data transmitted to the mobile terminal (1) on the basis of the resolution related information received. And, the symbol image data transmitting means (SC5B) transmits the symbol image data in correspondence with the resolution of the information display screen (11) of the mobile terminal (1), which is discriminated by the terminal resolution discrimination means (SC3).

Therefore, in the image data transmitting/receiving system (S) of embodiment 2 of the first invention, the latest symbol image data discrimination means (SC6) of the server (7) discriminates whether the symbol image data stored in the terminal-side symbol image data storage means (KC2) of the mobile terminal (1) are the latest data. It is only when the symbol image data in the mobile terminal (1) are determined as not being the latest by way of up-dating the symbol image data stored in the server-side symbol image data storage means (SC2A) and so forth, that the symbol image data are transmitted from the server (7) to the mobile terminal (1). As a result, in contrast to the case where the symbol image data is transmitted every time without a determination being made as to whether they are the latest, the image data transmitting/receiving system (S) of embodiment 2 of the first invention succeeds in effecting reduction of the quantity of data transmitted and received, and reduction of communication cost, and preventing communication jams. Further, since the server (7) discriminates whether the symbol image data are the latest data, processing by the mobile terminal (1) can be reduced, enabling the server (7) to manage the processing as a whole.

### Embodiment 3 of the First Invention

The image data transmitting/receiving system (S) of embodiment 3 of the first invention comprises the image data transmitting/receiving system (S) of the first invention, embodiment 1 of the first invention, or embodiment 2 of the first invention, and the server (7) provided with component (B12) and the mobile terminal (1) provided with components (A13) and (A14), as follows:

(B12), a map information transmitting means (SC5C) that transmits to the mobile terminal (1), map information including symbol image specifying information that specifies the symbol images, and location information that specifies locations where the specified symbol images are laid out,

(A13), a map information receiving means (KC11C) that receives the map information transmitted from the server (7), and

(A14), a map image creation means (KC5) that creates map images as the display images arranged on the information display screen (11), on the basis of map information and the symbol image data of symbol images as map symbol images.

Function of Embodiment 3 of the First Invention

In the image data transmitting/receiving system (S) of embodiment 3 of the first invention comprising the server (7) provided with component (B12) and the mobile terminal (1) provided with components (A13) and (A14), the map information transmitting means (SC5C) transmits the map information to the mobile terminal (1), including the symbol image specifying information that specifies the symbol images and the location information that specifies locations where the specified symbol images are laid out. The map information receiving means (KC11C) of the mobile terminal (1) receives the map information transmitted from the server (7). The map image creation means (KC5) of the mobile terminal (1) creates the map images as the display images arranged on the information display screen (11) on the basis of map information and the symbol image data of symbol images as map symbol images.

Therefore, in the image data transmitting/receiving system (S) of embodiment 3 of the first invention, the map images are created on the basis of map information transmitted from the server (7) and the map symbol images stored in the mobile terminal (1), and are displayed on the information display screen (11). Accordingly, the map images are displayed in correspondence with the resolution of the information display screen (11) of the mobile terminal (1), with the map symbols being ascribed appropriate sizes. As a result, the problem of symbol images becoming excessively small as to present viewing difficulties to the user can be effectively addressed.

The Second Invention

In order to solve the aforementioned technical problems, the inventors have formulated a second invention pertaining to an image data transmitting/receiving system (S) which comprises a mobile terminal (1) provided with components (C1) through (C4) and a server (7) provided with components (D1) through (D5), as follows:

(C1), an information display screen (11) on which information is displayed,

(C2), a resolution related information storage means (KC1) that stores resolution related information pertinent to the resolution of the information display screen (11),

(C3), a display image data transmission request information transmitting means (KC10C) that transmits display image data transmission requests for transmission of the display images arranged on the information display screen (11) and the resolution related information to the server (7),

(C4), a display image data receiving means (KC11C″) that receives display image data transmitted from the server (7),

(D1), a server-side symbol image data storage means (SC2A) that stores symbol image data in correspondence with the resolution of the information display screen (11) of the mobile terminal (1), which are used to create the display images partly constituting specific graphic symbols,

(D2), a display image data transmission request information receiving means (SC1C) that receives the display image data transmission requests and the resolution related information, which are transmitted from the mobile terminal (1),

(D3), a terminal resolution discrimination means (SC3) that discriminates the symbol image data in correspondence with the resolution of the information display screen (11), on the basis of the resolution related information received,

(D4), a display image creation means (SC4″) that creates the display images arranged on the information display screen (11) of the mobile terminal (1), using the symbol image data which is discriminated by the terminal resolution discrimination means (SC3), in correspondence with the resolution of the information display screen (11), and

(D5), a display image data transmitting means (SC5E) that transmits the display image data constituting the data of created display images.

Function of the Second Invention

In the image data transmitting/receiving system (S) of the second invention comprising the mobile terminal (1) provided with components (C1) through (C4) and the server (7) provided with components (D1) through (D5), the resolution related information storage means (KC1) of the mobile terminal (1) stores the resolution related information pertinent to the resolution of the information display screen (11) on which information is displayed. The display image data transmission request information transmitting means (KC10C) of the mobile terminal (1) transmits the display image data transmission requests for the transmission of display images arranged on the information display screen (11) and the resolution related information to the server (7).

The display image data transmission requests and the resolution related information which are transmitted from the mobile terminal (1) are received by the display image data transmission request information receiving means (SC1C) of the server (7). The symbol image data which are used in creating the display images partly constituting specific graphic symbols are stored in the server-side symbol image data storage means (SC2A) in correspondence with the resolution of the information display screen (11) of the mobile terminal (1). The terminal resolution discrimination means (SC3) of the server (7) discriminates the symbol image data in correspondence with the resolution of the information display screen (11), on the basis of the resolution related information received.

The display image creation means (SC4″) creates the display images arranged on the information display screen (11) of the mobile terminal (1), using the symbol image data which is discriminated by the terminal resolution discrimination means (SC3), in correspondence with the resolution of the information display screen (11). And, the display image data transmitting means (SC5E) transmits the display image data constituting the data of created display images.

The display image data transmitted from the server (7) are received by the display image data receiving means (KC11C″) of the server (7).

Therefore, in the image data transmitting/receiving system (S) of the second invention, the display images arranged on the information display screen (11) of the mobile terminal (1) are created not by the mobile terminal (1), but by the server (7). Here, the symbol image data corresponding to the resolution of the information display screen (11) of the mobile terminal (1) are used to create the display images. In this manner, display images of appropriate sizes in correspondence with the resolution of the information display screen (11) of the mobile terminal (1) on the information display screen (11) can be displayed. Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

The Third Invention

In order to solve the aforementioned technical problems, the server (7) of the third invention has been devised to be capable of transmitting to and receiving image data from a mobile terminal (1) comprising:

an information display screen (11) on which information is displayed,

a resolution related information storage means (KC1) that stores resolution related information pertinent to the resolution of the information display screen (11),

a terminal-side symbol image data storage means (KC2) that stores symbol image data which are used in creating display images partly constituting specific graphic symbols to be arranged on the information display screen (11),

a symbol image data transmission request information transmitting means (KC10B) that transmits symbol image data transmission requests for the transmission of the symbol image data stored in the server (7) and the resolution related information to the server (7), and

a symbol image data receiving means (KC11B) that receives the symbol image data transmitted from the server.

Further, the server (7) comprises components (B1) through (B4), as follows:

(B1), a server-side symbol image data storage means (SC2A) that stores the symbol image data in correspondence with the resolution of the information display screen (11) of the mobile terminal (1),

(B2), a symbol image data transmission request information receiving means (SC1B) that receives the symbol image data transmission requests and the resolution related information which are transmitted from the mobile terminal (1),

(B3), a terminal resolution discrimination means (SC3) that discriminates the symbol image data transmitted to the mobile terminal (1) on the basis of the resolution related information received, and

(B4) a symbol image data transmitting means (SC5B) that transmits the symbol image data which is discriminated by the terminal resolution discrimination means (SC3) in correspondence with the resolution of the information display screen (11) of the mobile terminal (1).

Function of the Third Invention

In the server (7) of the third invention including the above-mentioned components (B1) through (B4), the server-side symbol image data storage means (SC2A) stores the symbol image data in correspondence with the resolution of the information display screen (11) of the mobile terminal (1). The symbol image data transmission requests and the resolution related information which are transmitted from the mobile terminal (1) are received by the symbol image data transmission request information receiving means (SC1B). And, the terminal resolution discrimination means (SC3) discriminates the symbol image data transmitted to the mobile terminal (1) on the basis of the resolution related information received. The symbol image data transmitting means (SC5B) transmits the symbol image data which is discriminated by the terminal resolution discrimination means (SC3) in correspondence with the resolution of the information display screen (11) of the mobile terminal (1).

Therefore, the server (7) of the third invention transmits the symbol image data in correspondence with the resolution of the information display screen (11) of the mobile terminal (1). In consequence, the symbol image data corresponding to the resolution of the information display screen (11) are used to create the display images shown on the information display screen (11) of the mobile terminal (1). Accordingly, display images of appropriate sizes can be displayed on the information display screen (11) in correspondence with the resolution of the information display screen (11) of the mobile terminal (1). Therefore, where the information display screen (11) has high resolution capability, the problem of symbol images becoming excessively small for easy viewing can be solved. Conversely, where the information display screen (11) has low resolution capability, the problem of symbol images becoming excessively large and the display images (map images, for example) becoming difficult to view can be avoided.

### Embodiment 1 of the Third Invention

The server (7) of embodiment 1 of the third invention is capable of transmitting to and receiving image data from a mobile terminal (1) comprising:

a terminal-side image data identification information storage means (KC3) that stores terminal-side image data identification information constituting identification information of the symbol image data stored in the terminal-side symbol image data storage means (KC2), an identification information transmission request information transmitting means (KC10A) that transmits server-side image data identification information transmission requests for the server (7) to transmit server-side image data identification information constituting identification information of the symbol image data stored in the server (7), before creating images displayed on the information display screen (11),

a server-side image data identification information receiving means (KC11A) that receives the server-side image data identification information transmitted from the server (7),

a latest symbol image data discrimination means (KC4) that discriminates whether the symbol image data stored in the mobile terminal (1) are the latest data, on the basis of the server-side image data identification information and the terminal-side image data identification information received, and

the symbol image data transmission request information transmitting means (KC10B) that transmits the symbol image data transmission request information and the resolution related information to the server (7) when it is determined that the symbol image data stored in the mobile terminal (1) are not the latest data.

Further, the server (7) comprises components (B5) through (B7), as follows:

(B5), a server-side image data identification information storage means (SC2B) that stores the server-side image data identification information constituting identification information of the symbol image data stored in the server-side symbol image data storage means (SC2A),

(B6), a server-side image data identification information transmission request information receiving means (SC1A) that receives the server-side image data identification information transmission requests transmitted from the mobile terminal (1), and

(B7), a server-side image data identification information transmitting means (SC5A) that transmits the server-side image data identification information upon receiving the server-side image data identification information transmission requests.

Function of Embodiment 1 of the Third Invention

In the server (7) of embodiment 1 of the third invention which includes the above-mentioned components (B5)-through (B7), the server-side image data identification information storage means (SC2B) stores the server-side image data identification information comprising the identification information of the symbol image data stored in the server-side symbol image data storage means (SC2A). The server-side image data identification information transmission request information receiving means (SC1A) receives the server-side image data identification information transmission requests transmitted from the mobile terminal (1). The server-side image data identification information transmitting means (SC5A) transmits the server-side image data identification information upon receiving the server-side image data identification information transmission requests.

In this manner, the server (7) of embodiment 1 of the third invention is able to transmit the server-side image data identification information in response to the request from the mobile terminal (1). The mobile terminal (1) that has received the server-side image data identification information is able to discriminate whether or not the symbol image data stored in the mobile terminal (1) are the latest data. It is only upon a determination that they are not the latest that the symbol image data is transmitted from the server (7) to the mobile terminal (1). As a result, in contrast where the symbol image data is transmitted every time without a determination being made as to whether they are the latest, the server (7) of embodiment 1 of the third invention succeeds in effecting reduction of the quantity of data transmitted and received and reduction of communication cost, while preventing communication jams. Further, since the mobile terminal (1) discriminates whether or not the symbol image data are the latest data, the load on the server (7) will be reduced.

### Embodiment 2 of the Third Invention

The server (7) in the embodiment 2 of the third invention is capable of transmitting to and receiving image data from a mobile terminal (1) comprising:

a terminal-side image data identification information storage means (KC3) that stores terminal-side image data identification information constituting identification information of the symbol image data stored in the terminal-side symbol image data storage means (KC2),

the symbol image data transmission request information transmitting means (KC10B) that transmits the symbol image data transmission request information, the resolution related information, and the terminal-side image data identification information to the server (7), before creating images displayed on the information display screen (11),

a latest data notice information receiving means (KC11D) that receives the notice of information on the latest data indicating that the symbol image data stored in the terminal-side symbol image data storage means (KC2) are the latest data.

Further, the server (7) comprises components (B5), and (B8) through (B11), as follows:

(B5), a server-side image data identification information storage means (SC2B) that stores server-side image data identification information constituting identification information of the symbol image data stored in the server-side symbol image data storage means (SC2A),

(B8), the symbol image data transmission request information receiving means (SC1B) that receives the symbol image data transmission requests, the resolution related information, and the terminal-side image data identification information, which are transmitted from a mobile terminal (1),

(B9), a latest symbol image data discrimination means (SC6) that discriminates whether the symbol image data stored in the mobile terminal (1) are the latest data, on the basis of the terminal-side image data identification information and the server-side image data identification information received,

(B10), a latest data notice information transmitting means (SC5D) that transmits the notice of information on the latest data and does not transmit the symbol image data stored in the server (7) to the mobile terminal (1) when the symbol image data stored in the mobile terminal (1) are the latest data,

(B11), the terminal resolution discrimination means (SC3) that discriminates the transmitted symbol image data on the basis of the resolution related information received, when it is determined that the symbol image data stored in the mobile terminal (1) are not the latest data.

Function of Embodiment 2 of the Third Invention

In the server (7) in the embodiment 2 of the third invention including the above components (B5), and (B8) through (B11), the server-side image data identification information storage means (SC2B) stores the server-side image data identification information comprising the identification information of the symbol image data stored in the server-side symbol image data storage means (SC2A). The symbol image data transmission request information receiving means (SC1B) receives the symbol image data transmission requests, the resolution related information, and the terminal-side image data identification information, which are transmitted from the mobile terminal (1). The latest symbol image data discrimination means (SC6) discriminates whether the symbol image data stored in the mobile terminal (1) are the latest data on the basis of the terminal-side image data identification information and the server-side image data identification information received.

The latest data notice information transmitting means (SC5D) transmits the latest data notice information and does not transmit the symbol image data stored in the server (7) to the mobile terminal (1) when the symbol image data stored in the mobile terminal (1) have been determined as the latest data.

On the other hand, when the symbol image data stored in the mobile terminal (1) are not the latest, the terminal resolution discrimination means (SC3) discriminates the symbol image data transmitted to the mobile terminal (1) on the basis of the resolution related information received. And, the symbol image data transmitting means (SC5B) transmits the symbol image data in correspondence with the resolution of the information display screen (11) of the mobile terminal (1), which is discriminated by the terminal resolution discrimination means (SC3).

Therefore, in the server (7) of embodiment 2 of the third invention, whether or not the symbol image data stored in the terminal-side symbol image data storage means (KC2) are the latest is discriminated by the latest symbol image data discrimination means (SC6) of the server (7). And, it is only when the symbol image data in the mobile terminal (1) are determined as not being the latest by way of up-dating the symbol image data stored in the server-side symbol image data storage means (SC2A) and so forth, that the symbol image data are transmitted from the server (7) to the mobile terminal (1). As a result, in contrast to the case of where the symbol image data is transmitted every time without a determination being made as to whether they are the latest, the server 7 succeeds in effecting the reduction of the quantity of data transmitted and received, and reduction of communication cost, and preventing communication jams. Further, since the server (7) discriminates whether the symbol image data are the latest data, the processing by the mobile terminal (1) is reduced, enabling the server (7) to manage the processing as a whole.

The Fourth Invention

In order to solve the aforementioned technical problems, the mobile terminal (1) of the fourth invention has been devised to be capable of transmitting to and receiving image data from a server (7) comprising:

a server-side symbol image data storage means (SC2A) that stores symbol image data which are used in creating display images partly constituting specific graphic symbols arranged on the information display screen (11) of the mobile terminal (1) in correspondence with the resolution of the information display screen (11),

a symbol image data transmission request information receiving means (SC1B) that receives symbol image data transmission requests for transmitting the symbol image data stored in the server (7) and resolution related information pertinent to the resolution of the information display screen (11),

a terminal resolution discrimination means (SC3) that discriminates the symbol image data transmitted to the mobile terminal (1) on the basis of the resolution related information received, and

a symbol image data transmitting means (SC5B) that transmits the symbol image data which is discriminated by the terminal resolution discrimination means (SC3), in correspondence with the resolution of the information display screen (11) of the mobile terminal (1).

Further, the mobile terminal (1) comprises the components (A1) through (A5), as follows:

(A1), the information display screen (11),

(A2), the resolution related information storage means (KC1) that stores the resolution related information,

(A3), a terminal-side symbol image data storage means (KC2) that stores the symbol image data,

(A4), the symbol image data transmission request information transmitting means (KC10B) that transmits the symbol image data transmission requests and the resolution related information, and

(A5), a symbol image data receiving means (KC11B) that receives the symbol image data transmitted from the server (7).

Function of the Fourth Invention

In the mobile terminal (1) of the fourth invention comprising components (A1) through (A5), the resolution related information storage means (KC1) stores the resolution related information. The terminal-side symbol image data storage means (KC2) stores the symbol image data. And, the symbol image data transmission request information transmitting means (KC10B) transmits the symbol image data transmission requests and the resolution related information, and the symbol image data receiving means (KC11B) receives the symbol image data transmitted from the server (7). And, the symbol image data received by the symbol image data receiving means (KC11B) are stored in the terminal-side symbol image data storage means (KC2).

Therefore, in the mobile terminal (1) of the fourth invention, the symbol image data corresponding to the resolution of the information display screen (11) are stored in the terminal-side symbol image data storage means (KC2) of the mobile terminal (1). That is, when the display images arranged on the information display screen (11) are created, the symbol image data corresponding to the resolution are used. In this manner, display images of appropriate sizes in correspondence with the resolution of the information display screen (11) can be displayed. Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

### Embodiment 1 of the Fourth Invention

The mobile terminal (1) in the embodiment 1 of the fourth invention has been devised to be capable of transmitting to and receiving image data from a server (7) comprising:

a server-side image data identification information storage means (SC2B) that stores server-side image data identification information constituting identification information of the symbol image data stored in the server-side symbol image data storage means (SC2A),

a server-side image data identification information transmission request information receiving means (SC1A) that receives server-side image data identification information transmission requests transmitted from the mobile terminal (1) for transmission of the server-side image data identification information, and

a server-side image data identification information transmitting means (SC5A) that transmits the server-side image data identification information upon receiving the server-side image data identification information transmission request.

Further, the mobile terminal (1) comprises components (A6) through (A10), as follows:

(A6), a terminal-side image data identification information storage means (KC3) that stores terminal-side image data identification information constituting identification information of the symbol image data stored in the terminal-side symbol image data storage means (KC2),

(A7), an identification information transmission request information transmitting means (KC10A) that transmits the server-side image data identification information transmission requests to the server (7), before creating images displayed on the information display screen (11),

(A8), a server-side image data identification information receiving means (KC11A) that receives the server-side image data identification information transmitted from the server (7),

(A9), a latest symbol image data discrimination means (KC4) that discriminates whether the symbol image data stored in the mobile terminal (1) are the latest data, on the basis of the server-side image data identification information and the terminal-side image data identification information received, and

(A10), the symbol image data transmission request information transmitting means (KC10B) that transmits the symbol image data transmission requests and the resolution related information to the server (7), when the symbol image data stored in the mobile terminal (1) are determined as not being the latest data.

Function of Embodiment 1 of the Fourth Invention

In the mobile terminal (1) of embodiment 1 of the fourth invention comprising the components (A6) through (A10), the terminal-side image data identification information storage means (KC3) stores the terminal-side image data identification information comprising the identification information of the symbol image data stored in the terminal-side symbol image data storage means (KC2). The identification information transmission request information transmitting means (KC10A) transmits the server-side image data identification information transmission request to the server (7), before creating images displayed on the information display screen (11). The server-side image data identification information receiving means (KC11A) receives the server-side image data identification information transmitted from the server (7).

The latest symbol image data discrimination means (KC4) discriminates whether the symbol image data stored in the mobile terminal (1) are the latest data on the basis of the server-side image data identification information and the terminal-side image data identification information received. When the symbol image data stored in the mobile terminal (1) are determined as not being the latest, the symbol image data transmission request information transmitting means (KC10B) transmits the symbol image data transmission request information and the resolution related information to the server (7).

Therefore, in the mobile terminal (1) of embodiment 1 of the fourth invention, the latest symbol image data discrimination means (KC4) discriminates whether the symbol image data stored in the terminal-side symbol image data storage means (KC2) of the mobile terminal (1) are the latest data. It is only when the symbol image data in the mobile terminal (1) is determined as not being the latest by way of up-dating the symbol image data stored in the server-side symbol image data storage means (SC2A) and so forth, that the symbol image data are transmitted from the server (7) to the mobile terminal (1). As a result, in contrast to the case where the symbol image data is transmitted every time without a determination being made that it is the latest, the mobile terminal (1) of embodiment 1 of the fourth invention succeeds in effecting reduction of the quantity of data transmitted and received, and reduction of communication cost, while preventing communication jams. Further, since the mobile terminal (1) discriminates whether the symbol image data are the latest data, the load on the server (7) can be reduced.

### Embodiment 2 of the Fourth Invention

The mobile terminal (1) in the embodiment 2 of the fourth invention has been devised to be capable of transmitting to and receiving image data from a server (7) comprising:

a server-side image data identification information storage means (SC2B) that stores the server-side image data identification information constituting identification information of the symbol image data stored in the server-side symbol image data storage means (SC2A),

a symbol image data transmission request information receiving means (SC1B) that receives the symbol image data transmission requests, the resolution related information, and the terminal-side image data identification information comprising identification information of the symbol image data stored in the terminal-side symbol image data storage means (KC2) which are transmitted from the mobile terminal (1),

a latest symbol image data discrimination means (SC6) that discriminates whether the symbol image data stored in the mobile terminal (1) are the latest data, on the basis of the terminal-side image data identification information and the server-side image data identification information received,

a latest data notice information transmitting means (SC5D) that transmits the notice of information on the latest data indicating that the symbol image data stored in the terminal-side symbol image data storage means (KC2) are the latest and does not transmit the symbol image data stored in the server (7) to the mobile terminal (1) when the symbol image data stored in the mobile terminal (1) are determined as being the latest data,

the terminal resolution discrimination means (SC3) that discriminates the transmitted symbol image data on the basis of the resolution related information received when the symbol image data stored in the mobile terminal (1) are determined as not being the latest.

Further, the mobile terminal (1) comprises components (A6), (A11), and (A12), as follows:

(A6), the terminal-side image data identification information storage means (KC3) that stores the terminal-side image data identification information,

(A11), the symbol image data transmission request information transmitting means (KC10B) that transmits the symbol image data transmission requests the resolution related information, and the terminal-side image data identification information to the server (7) before creating images displayed on the information display screen (11),

(A12), a latest data notice information receiving means (KC11D) that receives notice of information on latest data indicating that the symbol image data stored in the terminal-side symbol image data storage means (KC2) are the latest data,

Function of Embodiment 2 of the Fourth Invention

In the mobile terminal (1) of embodiment 2 of the fourth invention comprising components (A6), (A11), and (A12), the terminal-side image data identification information storage means (KC3) stores the terminal-side image data identification information. The symbol image data transmission request information transmitting means (KC10B) transmits the symbol image data transmission request information, the resolution related information, and the terminal-side image data identification information to the server (7) before creating images displayed on the information display screen (11). And, the latest data notice information receiving means (KC11D) receives notice of information on latest data transmitted from the server (7), indicating that the symbol image data stored in the terminal-side symbol image data storage means (KC2) are the latest data.

Therefore, in the mobile terminal (1) of embodiment 2 of the fourth invention, the latest symbol image data discrimination means (SC6) of the server (7) discriminates whether the symbol image data stored in the terminal-side symbol image data storage means (KC2) are the latest data. And, when the symbol image data in the mobile terminal (1) are determined as not being the latest by way of up-dating the symbol image data stored in the server-side symbol image data storage means (SC2A) and so forth, the symbol image data are transmitted from the server (7) to the mobile terminal (1). On the other hand, when the symbol image data in the mobile terminal (1) have been determined as being the latest, the latest data notice information is transmitted, and the symbol image data are not transmitted.

As a result, in contrast to the case where the symbol image data is transmitted every time without a determination being made that it is the latest, the mobile terminal (1) of embodiment 2 of the fourth invention succeeds in effecting reduction of the quantity of data transmitted and received, and reduction of communication cost, while preventing communication jams. Further, since the server (7) discriminates whether the symbol image data are the latest data, the processing by the mobile terminal (1) is reduced, enabling the server (7) to manage the processing as a whole.

The Fifth Invention

In order to solve the aforementioned technical problems, the server (7) of the fifth invention has been devised to be capable of transmitting to and receiving image data from a mobile terminal (1) comprising:

an information display screen (11) on which information is displayed,

a resolution related information storage means (KC1) that stores resolution related information pertinent to the resolution of the information display screen (11),

a display image data transmission request information transmitting means (KC10C) that transmits display image data transmission requests for transmission of the display images arranged on the information display screen (11) and the resolution related information to the server (7), and

a display image data receiving means (KC11C″) that receives display image data transmitted from the server (7).

Further, the server (7) comprises components (D1) through (D5), as follows:

(D1), a server-side symbol image data storage means (SC2A) that stores symbol image data which are used to create the display images partly constituting specific graphic symbols, in correspondence with the resolution of the information display screen (11) of the mobile terminal (1),

(D2), a display image data transmission request information receiving means (SC1C) that receives the display image data transmission requests and the resolution related information, which are transmitted from the mobile terminal (1),

(D3), a terminal resolution discrimination means (SC3) that discriminates the symbol image data in correspondence with the resolution of the information display screen (11), on the basis of the resolution related information received,

(D4), a display image creation means (SC4″) that creates the display images arranged on the information display screen (11) of the mobile terminal (1), using the symbol image data which is discriminated by the terminal resolution discrimination means (SC3), in correspondence with the resolution of the information display screen (11), and

(D5), a display image data transmitting means (SC5E) that transmits the display image data constituting the data of created display images.

Function of the Fifth Invention

In the server (7) of the fifth invention comprising components (D1) through (D5), the server-side symbol image data storage means (SC2A) stores the symbol image data which are used in creating the display images partly constituting specific graphic symbols, in correspondence with the resolution of the information display screen (11) of the mobile terminal (1). The display image data transmission request information receiving means (SC1C) receives the display image data transmission requests and the resolution related information which are transmitted from the mobile terminal (1).

The terminal resolution discrimination means (SC3) discriminates the symbol image data in correspondence with the resolution of the information display screen (11), on the basis of the resolution related information received. The display image creation means (SC4″) creates the display images arranged on the information display screen (11) of the mobile terminal (1), using the symbol image data discriminated by the terminal resolution discrimination means (SC3), in correspondence with the resolution of the information display screen (11). The display image data transmitting means (SC5E) transmits the display image data constituting the data of created display images.

Therefore, in the server (7) of the fifth invention, the display images arranged on the information display screen (11) of the mobile terminal (1) are created not by the mobile terminal (1), but by the server (7). Here, the symbol image data corresponding to the resolution of the information display screen (11) of the mobile terminal (1) are used to create the display images. As a result, display images of appropriate sizes in correspondence with the resolution of the information display screen (11) of the mobile terminal (1) on the information display screen (11) can be displayed. Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

The Sixth Invention

In order to solve the aforementioned technical problems, the mobile terminal (1) of the sixth invention has been devised to be capable of transmitting to and receiving image data from a server (7) comprising:

a server-side symbol image data storage means (SC2A) that stores symbol image data which are used to create the display images partly constituting specific graphic symbols arranged in correspondence with the resolution of the information display screen (11) of the mobile terminal (1),

a display image data transmission request information receiving means (SC1C) that receives display image data transmission requests for transmission of the display images arranged on the information display screen (11) and resolution related information pertinent to the resolution of the information display screen (11),

a terminal resolution discrimination means (SC3) that discriminates the symbol image data in correspondence with the resolution of the information display screen (11), on the basis of the resolution related information received,

a display image creation means (SC4″) that creates the display images arranged on the information display screen (11) of the mobile terminal (1), using the symbol image data which is discriminated by the terminal resolution discrimination means (SC3) in correspondence with the resolution of the information display screen (11), and

a display image data transmitting means (SC5E) that transmits display image data constituting the data of created display images.

Further, the mobile terminal (1) comprises components (C1) through (C4), as follows:

(C1), the information display screen (11) on which information is displayed,

(C2), a resolution related information storage means (KC1) that stores the resolution related information pertinent to the resolution of the information display screen (11),

(C3), a display image data transmission request information transmitting means (KC10C) that transmits the display image data transmission requests for transmission of the display images arranged on the information display screen (11) and the resolution related information to the server (7), and

(C4), a display image data receiving means (KC11C″) that receives the display image data transmitted from the server (7).

Function of the Sixth Invention

In the mobile terminal (1) of the sixth invention provided with components (C1) through (C4), the resolution related information storage means (KC1) stores the resolution related information pertinent to the resolution of the information display screen (11) on which information is displayed. The display image data transmission request information transmitting means (KC10C) transmits the display image data transmission requests for transmission of the display images arranged on the information display screen (11) and the resolution related information to the server (7). The display image data receiving means (KC11C″) receives the display image data transmitted from the server (7).

Therefore, in the mobile terminal (1) of the sixth invention, the display images arranged on the information display screen (11) of the mobile terminal (1) are created not by the mobile terminal (1), but by the server (7). Here, the symbol image data corresponding to the resolution of the information display screen (11) of the mobile terminal (1) are used to create the display images. In this manner, display images of appropriate sizes in correspondence with the resolution of the information display screen (11) of the mobile terminal (1) can be displayed. Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

The Seventh Invention

In order to solve the aforementioned technical problems, the program (AP3, AP3′) for the server (7) of the seventh invention has been devised to run on a computer included in the server (7) capable of transmitting to and receiving image data from a mobile terminal (1) comprising:

an information display screen (11) on which information is displayed,

a resolution related information storage means (KC1) that stores resolution related information pertinent to resolution of the information display screen (11),

a terminal-side symbol image data storage means (KC2) that stores symbol image data which are used to create display images partly constituting specific graphic symbols to be arranged on the information display screen (11), in correspondence with the resolution of the information display screen (11) of the mobile terminal (1),

a symbol image data transmission request information transmitting means (KC10B) that transmits symbol image data transmission requests to transmit the symbol image data stored in the server (7) and the resolution related information to the server (7), and

a symbol image data receiving means (KC11B) that receives the symbol image data transmitted from the server (7).

Further, the program causes the computer to function as:

a server-side symbol image data storage means (SC2A) that stores the symbol image data in correspondence with the resolution of the information display screen (11) of the mobile terminal (1),

a symbol image data transmission request information receiving means (SC1B) that receives the symbol image data transmission requests and the resolution related information which are transmitted from the mobile terminal (1),

a terminal resolution discrimination means (SC3) that discriminates the symbol image data transmitted to the mobile terminal (1) on the basis of the resolution related information received, and

a symbol image data transmitting means (SC5B) that transmits the symbol image data which is discriminated by the terminal resolution discrimination means (SC3) in correspondence with the resolution of the information display screen (11) of the mobile terminal (1).

Function of the Seventh Invention

By means of the program (AP3, AP3′) for the server (7) of the seventh invention including the above-mentioned components, the server-side symbol image data storage means (SC2A) stores the symbol image data in correspondence with the resolution of the information display screen (11) of the mobile terminal (1). The symbol image data transmission request information receiving means (SC1B) receives the symbol image data transmission requests and the resolution related information which are transmitted from the mobile terminal (1). The terminal resolution discrimination means (SC3) discriminates the symbol image data transmitted to the mobile terminal (1) on the basis of the resolution related information received. The symbol image data transmitting means (SC5B) transmits the symbol image data which is discriminated by the terminal resolution discrimination means (SC3) in correspondence with the resolution of the information display screen (11) of the mobile terminal (1).

Therefore, in the program (AP3, AP3′) for the server (7) of the seventh invention, the server (7) is able to transmit the symbol image data in correspondence with the resolution of the information display screen (11) of the mobile terminal (1). As a result, the symbol image data corresponding to the resolution are used to create the display images arranged on the information display screen (11) of the mobile terminal (1). In this manner, display images of appropriate sizes in correspondence with the resolution of the information display screen (11) of the mobile terminal (1) can be displayed. Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

### Embodiment 1 of the Seventh Invention

The program (AP3) for the server (7) of embodiment 1 of the seventh invention runs on a computer included in the server (7) capable of transmitting to and receiving image data from a mobile terminal (1) comprising:

a terminal-side image data identification information storage means (KC3) that stores terminal-side image data identification information constituting identification information of the symbol image data stored in the terminal-side symbol image data storage means (KC2),

an identification information transmission request information transmitting means (KC10A) that transmits server-side image data identification information transmission requests for the server (7) to transmit server-side image data identification information constituting identification information of the symbol image data stored in the server (7), before creating images displayed on the information display screen (11),

a server-side image data identification information receiving means (KC11A) that receives the server-side image data identification information transmitted from the server (7),

a latest symbol image data discrimination means (KC4) that discriminates whether the symbol image data stored in the mobile terminal (1) are the latest data on the basis of the server-side image data identification information and the terminal-side image data identification information received, and

the symbol image data transmission request information transmitting means (KC10B) that transmits the symbol image data transmission request information and the resolution related information to the server (7) when the symbol image data stored in the mobile terminal (1) are determined as not being the latest data.

Further, the program causes the computer to function as:

a server-side image data identification information storage means (SC2B) that stores the server-side image data identification information constituting identification information of the symbol image data stored in the server-side symbol image data storage means (SC2A),

a server-side image data identification information transmission request information receiving means (SC1A) that receives the server-side image data identification information transmission requests transmitted from the mobile terminal (1), and

a server-side image data identification information transmitting means (SC5A) that transmits the server-side image data identification information upon receiving the server-side image data identification information transmission requests.

Function of Embodiment 1 of the Seventh Invention

In the program (AP3) for the server (7) of embodiment 1 of the seventh invention including the above-mentioned components, the server-side image data identification information storage means (SC2B) stores the server-side image data identification information constituting the identification information of the symbol image data stored in the server-side symbol image data storage means (SC2A). The server-side image data identification information transmission request information receiving means (SC1A) receives the server-side image data identification information transmission requests transmitted from the mobile terminal (1). The server-side image data identification information transmitting means (SC5A) transmits the server-side image data identification information upon receiving the server-side image data identification information transmission requests.

Therefore, in the program (AP3) for the server (7) of embodiment 1 of the seventh invention, the server-side image data identification information can be transmitted in response to the request coming from the mobile terminal (1). And, the mobile terminal (1) that has received the server-side image data identification information is able to discriminate whether the symbol image data stored in the mobile terminal (1) are the latest data. It is only upon a determination has been made that they are not the latest that the symbol image data can be transmitted from the server (7) to the mobile terminal (1). As a result, in contrast to the case where the symbol image data is transmitted every time without a determination being made that it is the latest, the program (AP3) for the server (7) of embodiment 1 of the seventh invention succeeds in effecting reduction of the quantity of data transmitted and received, and reduction of communication cost, while preventing communication jams. Further, since the mobile terminal 1 discriminates whether the symbol image data are the latest data, the load on the server (7) will be reduced.

### Embodiment 2 of the Seventh Invention

The program (AP3′) for the server (7) of embodiment 2 of the seventh invention has been devised to run on a computer included in the server (7) capable of transmitting to and receiving image data from a mobile terminal (1) comprising:

a terminal-side image data identification information storage means (KC3) that stores terminal-side image data identification information constituting identification information of the symbol image data stored in the terminal-side symbol image data storage means (KC2),

the symbol image data transmission request information transmitting means (KC10B) that transmits the symbol image data transmission requests, the resolution related information, and the terminal-side image data identification information to the server (7) before creating images displayed on the information display screen (11), and

a latest data notice information receiving means (KC11D) that receives the notice of information on the latest data indicating that the symbol image data stored in the terminal-side symbol image data storage means (KC2) are the latest data.

Further, the program causes the computer to function as:

a server-side image data identification information storage means (SC2B) that stores server-side image data identification information constituting identification information of the symbol image data stored in the server-side symbol image data storage means (SC2A),

the symbol image data transmission request information receiving means (SC1B) that receives the symbol image data transmission request information, the resolution related information, and the terminal-side image data identification information which are transmitted from the mobile terminal (1),

a latest symbol image data discrimination means (SC6) that discriminates whether the symbol image data stored in the mobile terminal (1) are the latest data on the basis of the terminal-side image data identification information and the server-side image data identification information received,

a latest data notice information transmitting means (SC5D) that transmits the latest data notice information and does not transmit the symbol image data stored in the server (7) to the mobile terminal (1), when the symbol image data stored in the mobile terminal (1) have been determined as being the latest, and

the terminal resolution discrimination means (SC3) that discriminates the transmitted symbol image data on the basis of the resolution related information received, when the symbol image data stored in the mobile terminal (1) have been determined as not being the latest. Function of Embodiment 2 of the Seventh Invention

In the program (AP3′) for the server (7) of embodiment 2 of the seventh invention including the above-mentioned components, the server-side image data identification information storage means (SC2B) stores the server-side image data identification information constituting the identification information of the symbol image data stored in the server-side symbol image data storage means (SC2A). The symbol image data transmission request information receiving means (SC1B) receives the symbol image data transmission requests, the resolution related information, and the terminal-side image data identification information which are transmitted from the mobile terminal (1). The latest symbol image data discrimination means (SC6) discriminates whether the symbol image data stored in the mobile terminal (1) are the latest data on the basis of the terminal-side image data identification information and the server-side image data identification information received.

When the symbol image data stored in the mobile terminal (1) have been determined as being the latest, the latest data notice information transmitting means (SC5D) transmits the latest data notice information and does not transmit the symbol image data stored in the server (7) to the mobile terminal (1). On the other hand, when the symbol image data stored in the mobile terminal (1) have been determined as not being the latest, the terminal resolution discrimination means (SC3) discriminates the symbol image data transmitted to the mobile terminal (1) on the basis of the resolution related information received.

Therefore, in the program (AP3′) for the server (7) of embodiment 2 of the seventh invention, the latest symbol image data discrimination means (SC6) of the server (7) discriminates whether the symbol image data stored in the terminal-side symbol image data storage means (KC2) of the mobile terminal (1) are the latest data. It is only when the symbol image data in the mobile terminal (1) have been determined as not being the latest by way of up-dating the symbol image data stored in the server-side symbol image data storage means (SC2A) and so forth, that the symbol image data are transmitted from the server (7) to the mobile terminal (1). As a result, in contrast to the case where the symbol image data is transmitted every time without a determination being made that it is the latest, the program (AP3′) for the server (7) of embodiment 2 of the seventh invention succeeds in effecting reduction of the quantity of data transmitted and received, and reduction of communication cost, while preventing communication jams. Further, since the server (7) discriminates whether the symbol image data are the latest data, the processing by the mobile terminal (1) is reduced, enabling the server (7) to manage the processing as a whole.

The Eighth Invention

In order to solve the aforementioned technical problems, the program (AP1, API′) for the mobile terminal (1) of the eighth invention has been devised to run on a computer included in the mobile terminal (1) capable of transmitting u receiving image data from a server (7) comprising:

a server-side symbol image data storage means (SC2A) that stores symbol image data which are used to create the display images partly constituting specific graphic symbols, in correspondence with the resolution of the information display screen (11) of the mobile terminal (1),

a symbol image data transmission request information receiving means (SC1B) that receives symbol image data transmission requests to transmit the symbol image data stored in the server (7) and resolution related information pertinent to the resolution of the information display screen (11) of the mobile terminal (1),

a terminal resolution discrimination means (SC3) that discriminates the symbol image data transmitted to the mobile terminal (1) on the basis of the resolution related information received, and

a symbol image data transmitting means (SC5B) that transmits the symbol image data which is discriminated by the terminal resolution discrimination means (SC3) in correspondence with the resolution of the information display screen (11) of the mobile terminal (1).

Further, the program makes the computer function as:

a resolution related information storage means (KC1) that stores the resolution related information,

a terminal-side symbol image data storage means (KC2) that stores the symbol image data,

a symbol image data transmission request information transmitting means (KC10B) that transmits the symbol image data transmission requests and the resolution related information, and

a symbol image data receiving means (KC11B) that receives the symbol image data transmitted from the server (7).

Function of the Eighth Invention

In the program (AP1, AP1′) for the mobile terminal (1) of the eighth invention including the above-mentioned components; the resolution related information storage means (KC1) stores the resolution related information. The terminal-side symbol image data storage means (KC2) stores the symbol image data. The symbol image data transmission request information transmitting means (KC10B) transmits the symbol image data transmission requests and the resolution related information, and the symbol image data receiving means (KC11B) receives the symbol image data transmitted from the server (7). The symbol image data received by the symbol image data receiving means (KC11B) are stored in the terminal-side symbol image data storage means (KC2).

Therefore, in the program (AP1, AP1′) provided for the mobile terminal (1) in the eighth invention, the symbol image data corresponding to the resolution of the information display screen (11) are stored in the terminal-side symbol image data storage means (KC2) of the mobile terminal (1). That is, when the display images arranged on the information display screen (11) are created, the symbol image data corresponding to the resolution are used. In this manner, display images of appropriate sizes in correspondence with the resolution of the information display screen (11) can be displayed. Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

### Embodiment 1 of the Eighth Invention

The program (AP1) for the mobile terminal (1) of embodiment 1 of the eighth invention has been devised to run on a computer included in the mobile terminal (1) capable of transmitting to and receiving image data from a server (7) comprising:

a server-side image data identification information storage means (SC2B) that stores server-side image data identification information constituting identification information of the symbol image data stored in the server-side symbol image data storage means (SC2A),

a server-side image data identification information transmission request information receiving means (SC1A) that receives server-side image data identification information transmission requests for transmission of the server-side image data identification information which is transmitted from the mobile terminal (1), and

a server-side image data identification information transmitting means (SC5A) that transmits the server-side image data identification information upon receiving the server-side image data identification information transmission requests.

Further, the program causes the computer to function as:

a terminal-side image data identification information storage means (KC3) that stores terminal-side image data identification information constituting identification information of the symbol image data stored in the terminal-side symbol image data storage means (KC2),

an identification information transmission request information transmitting means (KC10A) that transmits the server-side image data identification information transmission requests to the server (7) before creating images displayed on the information display screen (11),

a server-side image data identification information receiving means (KC11A) that receives the server-side image data identification information transmitted from the server (7),

a latest symbol image data discrimination means (KC4) that discriminates whether the symbol image data stored in the mobile terminal (1) are the latest data on the basis of the server-side image data identification information and the terminal-side image data identification information received, and

the symbol image data transmission request information transmitting means (KC10B) that transmits the symbol image data transmission request information and the resolution related information to the server (7) when the symbol image data stored in the mobile terminal (1) have been determined as not being the latest.

Function of Embodiment 1 of the Eighth Invention

In the program (AP1) for the mobile terminal (1) of embodiment 1 of the eighth invention including the above-mentioned components, the terminal-side image data identification information storage means (KC3) stores the terminal-side image data identification information constituting the identification information of the symbol image data stored in the terminal-side symbol image data storage means (KC2). The identification information transmission request information transmitting means (KC10A) transmits the server-side image data identification information transmission requests to the server (7) before creating images displayed on the information display screen (11). The server-side image data identification information receiving means (KC11A) receives the server-side image data identification information transmitted from the server (7).

The latest symbol image data discrimination means (KC4) discriminates whether the symbol image data stored in the mobile terminal (1) are the latest data on the basis of the server-side image data identification information and the terminal-side image data identification information received. When the symbol image data stored in the mobile terminal (1) have been determined as not being the latest, the symbol image data transmission request information transmitting means (KC10B) transmits the symbol image data transmission requests and the resolution related information to the server (7).

Therefore, in the program (AP1) provided for the mobile terminal (1) of embodiment 1 of the eighth invention, the latest symbol image data discrimination means (KC4) of the mobile terminal (1) discriminates whether the symbol image data stored in the terminal-side symbol image data storage means (KC2) of the mobile terminal (1) are the latest data. It is only when the symbol image data in the mobile terminal (1) have been determined as not being the latest by way of up-dating the symbol image data stored in the server-side symbol image data storage means (SC2A) and so forth, that the symbol image data are transmitted from the server (7) to the mobile terminal (1).

As a result, in contrast to the case where the symbol image data is transmitted every time without a determination being made that it is the latest, the program (AP1) for the mobile terminal (1) of embodiment 1 of the eighth invention succeeds in effecting reduction of the quantity of data transmitted and received, and reduction of communication cost, while preventing communication jams. Further, since the mobile terminal (1) discriminates whether the symbol image data are the latest data, the load on the server (7) will be reduced.

### Embodiment 2 of the Eighth Invention

The program (AP1′) for the mobile terminal (1) of embodiment 2 of the eighth invention has been devised to run on a computer included in the mobile terminal (1) capable of transmitting to and receiving image data from a server (7) comprising:

a server-side image data identification information storage means (SC2B) that stores server-side image data identification information constituting identification information of the symbol image data stored in the server-side symbol image data storage means (SC2A),

the symbol image data transmission request information receiving means (SC1B) that receives the symbol image data transmission requests, the resolution related information, and the terminal-side image data identification information constituting identification information of the symbol image data stored in the terminal-side symbol image data storage means (KC2) which are transmitted from the mobile terminal (1),

a latest symbol image data discrimination means (SC6) that discriminates whether the symbol image data stored in the mobile terminal (1) are the latest data on the basis of the terminal-side image data identification information and the server-side image data identification information received,

a latest data notice information transmitting means (SC5D) that transmits notice of information on the latest data indicating that the symbol image data stored in the terminal-side symbol image data storage means (KC2) are the latest and does not transmit the symbol image data stored in the server (7) to the mobile terminal (1), when the symbol image data stored in the mobile terminal (1) have been determined as being the latest.

the terminal resolution discrimination means (SC3) that discriminates the transmitted symbol image data on the basis of the resolution related information received, when the symbol image data stored in the mobile terminal (1) have been determined as not being the latest.

Further, the program causes the computer to function as:

a terminal-side image data identification information storage means (KC3) that stores the terminal-side image data identification information,

the symbol image data transmission request information transmitting means (KC10B) that transmits the symbol image data transmission request information, the resolution related information, and the terminal-side image data identification information to the server (7), before creating images displayed on the information display screen (11), and

a latest data notice information receiving means (KC11D) that receives latest data notice information indicating that the symbol image data stored in the terminal-side symbol image data storage means (KC2) are the latest data.

Function of Embodiment 2 of the Eighth Invention

In the program (AP1′) for the mobile terminal (1) of embodiment 2 of the eighth invention including the above-mentioned components, the terminal-side image data identification information storage means (KC3) stores the terminal-side image data identification information. The symbol image data transmission request information transmitting means (KC10B) transmits the resolution related information, and the terminal-side image data identification information to the server (7), before creating images displayed on the information display screen (11), the symbol image data transmission request information. And, the latest data notice information receiving means (KC11D) receives the latest data notice information transmitted from the server (7) indicating that the symbol image data stored in the terminal-side symbol image data storage means (KC2) are the latest data.

Therefore, in the program (AP1′) provided for the mobile terminal (1) of embodiment 2 of the eighth invention, the latest symbol image data discrimination means (SC6) of the server (7) discriminates whether the symbol image data stored in the terminal-side symbol image data storage means (KC2) are the latest data. And, when the symbol image data in the mobile terminal (1) are determined as not being the latest by way of up-dating the symbol image data stored in the server-side symbol image data storage means (SC2A) and so forth, the symbol image data are transmitted from the server (7) to the mobile terminal (1). On the other hand, when the symbol image data in the mobile terminal (1) are determined as being the latest, the latest data notice information is transmitted, and the symbol image data are not transmitted.

As a result, in contrast to the case of where the symbol image data is transmitted every time without a determination being made as to whether they are the latest, the program (AP1′) provided for the mobile terminal (1) of embodiment 2 of the eighth invention succeeds in effecting the reduction of the quantity of data transmitted and received, and reduction of communication cost, and preventing communication jams. Further, since the server (7) discriminates whether the symbol image data are the latest data, the processing by the mobile terminal (1) is reduced, enabling the server (7) to manage the processing as a whole.

The Ninth Invention

In order to solve the aforementioned technical problems, the program (AP3″) for the server (7) of the ninth invention has been devised to run on a computer included in the server (7) capable of transmitting to and receiving image data from a mobile terminal (1) comprising:

an information display screen (11) on which information is displayed,

a resolution related information storage means (KC1) that stores resolution related information pertinent to the resolution of the information display screen (11),

a display image data transmission request information transmitting means (KC10C) that transmits display image data transmission requests for transmission of the display images arranged on the information display screen (11) and the resolution related information to the server (7), and

a display image data receiving means (KC11C″) that receives display image data transmitted from the server (7).

Further, the program causes the computer to function as:

a server-side symbol image data storage means (SC2A) that stores the symbol image data which are used to create the display images partly constituting specific graphic symbols, in correspondence with the resolution of the information display screen (11) of the mobile terminal (1),

a display image data transmission request information receiving means (SC1C) that receives the display image data transmission requests and the resolution related information which are transmitted from the mobile terminal (1),

a terminal resolution discrimination means (SC3) that discriminates the symbol image data in correspondence with the resolution of the information display screen (11) of the mobile terminal on the basis of the received resolution related information,

a display image creation means (SC4″) that creates the display images arranged on the information display screen (11) of the mobile terminal (1), using the symbol image data which is discriminated by the terminal resolution discrimination means in correspondence with the resolution of the information display screen (11) of the mobile terminal (1), and

a display image data transmitting means (SC5E) that transmits the display image data constituting the data of created display images.

Function of the Ninth Invention

In the program (AP3″) for the server (7) of the ninth invention including the above-mentioned components, the server-side symbol image data storage means (SC2A) stores the symbol image data which are used to create the display images partly constituting specific graphic symbols, in correspondence with the resolution of the information display screen (11) of the mobile terminal (1). The display image data transmission request information receiving means (SC1C) receives the display image data transmission requests and the resolution related information which are transmitted from the mobile terminal (1).

The terminal resolution discrimination means (SC3) discriminates the symbol image data in correspondence with the resolution of the information display screen (11) on the basis of the resolution related information received. The display image creation means (SC4″) creates the display images arranged on the information display screen (11) of the mobile terminal (1), using the symbol image data in correspondence with the resolution of the information display screen (11), which is discriminated by the terminal resolution discrimination means (SC3). The display image data transmitting means (SC5E) transmits the display image data constituting the data of created display images.

Therefore, in the program (AP3″) for the server (7) of the ninth invention, the display images arranged on the information display screen (11) of the mobile terminal (1) are created not by the mobile terminal (1), but by the server (7). Here, the symbol image data corresponding to the resolution of the information display screen (11) of the mobile terminal (1) are used to create the display images. In this manner, display images of appropriate sizes in correspondence with the resolution of the information display screen (11) can be displayed on the information display screen (11) of the mobile terminal (1). Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

The Tenth Invention

In order to solve the aforementioned technical problems, the program (AP1″) for the mobile terminal (1) of the tenth invention has been designed to run on a computer included in the mobile terminal (1) capable of transmitting to and receiving image data from a server (7) comprising:

a server-side symbol image data storage means (SC2A) that stores symbol image data in correspondence with the resolution of an information display screen (11) of the mobile terminal (1), which are used in creating display images partly constituting specific graphic symbols arranged on the information display screen (11) of the mobile terminal (1),

a display image data transmission request information receiving means (SC1C) that receives display image data transmission requests to transmit the display images arranged on the information display screen (11), and the resolution related information pertinent to the resolution of the information display screen (11) of the mobile terminal (1),

a terminal resolution discrimination means (SC3) that discriminates the symbol image data in correspondence with the resolution of the information display screen (11) of the mobile terminal (1) on the basis of the resolution related information received,

a display image creation means (SC4″) that creates the display images arranged on the information display screen (11) of the mobile terminal (1), using the symbol image data which is discriminated by the terminal resolution discrimination means (SC3) in correspondence with the resolution of the information display screen (11) of the mobile terminal (1), and

a display image data transmitting means (SC5E) that transmits display image data constituting the data of created display images.

Further, the program causes the computer to function as:

a resolution related information storage means (KC1) that stores resolution related information pertinent to the resolution of the information display screen (11) on which information is displayed,

a display image data transmission request information transmitting means (KC10C) that transmits display image data transmission requests for transmission of the display images arranged on the information display screen (11) and the resolution related information to the server (7), and

a display image data receiving means (KC11C″) that receives the display image data transmitted from the server (7).

Function of the Tenth Invention

In the program (AP1″) for the mobile terminal (1) of the tenth invention including the above-mentioned components, the resolution related information storage means (KC1) stores the resolution related information pertinent to the resolution of the information display screen (11) on which information is displayed. The display image data transmission request information transmitting means (KC10C) transmits the display image data transmission requests for transmission of the display images arranged on the information display screen (11) and the resolution related information to the server (7). The display image data receiving means (KC11C″) receives the display image data transmitted from the server (7).

Therefore, in the program (AP1″) provided for the mobile terminal (1) in the tenth invention, the display images arranged on the information display screen (11) of the mobile terminal (1) are created not by the mobile terminal (1), but by the server (7). Here, the symbol image data corresponding to the resolution of the information display screen (11) of the mobile terminal (1) are used to create the display images. In this manner, display images of appropriate sizes in correspondence with the resolution of the information display screen (11) can be displayed on the information display screen (11) of the mobile terminal (1). Therefore, where the information display screen (11) has high resolution capability, the problem of symbol images becoming excessively small as to present viewing difficulties for the user can be addressed effectively. Conversely, where the information display screen (11) has low resolution capability, the problem of symbol images becoming excessively large and the display images (map images, for example) becoming difficult to view can be avoided.

It is also possible to record the programs of the seventh, eighth, ninth and tenth inventions on a computer-readable recording medium.

The present invention thus described exhibits the following functions.

It is possible to display images of optimum size in correspondence with the resolution of the information display screen of the mobile terminal.

It is possible to prevent useless transmission or reception of data, and to reduce the quantity of data communication by discriminating whether or not the symbol image data stored in the mobile terminal are the latest data.

It is also possible to reduce the load on the server by causing the mobile terminal to discriminate whether or not the symbol image data stored in the mobile terminal are the latest data.

### BRIEF DESCRIPTION OF THE DRAWINGS

FIG. 1 is an explanatory chart of the image data transmitting/receiving system of Example 1 relating to the present invention;

FIG. 2 is a functional block diagram of a mobile terminal in the image data transmitting/receiving system referred to in FIG. 1;

FIG. 3 is an example of a search condition input image displayed on an information display screen of the mobile phone of Example 1;

FIG. 4 is a functional block diagram of a server in the image data transmitting/receiving system referred to in FIG. 1;

FIG. 5 is a main flow chart of a map display application program provided for the mobile terminal in the image data transmitting/receiving system of Example 1;

FIG. 6 is a flow chart of a symbol image data transmitting/receiving processing performed by the mobile terminal of Example 1, which is a flow chart of a subroutine at ST2 in FIG. 5;

FIG. 7 is a main flow chart of a map data delivery application program provided for the server in the image data transmitting/receiving system of Example 1;

FIG. 8 is an example of a map image displayed on the information display screen of the mobile terminal of Example 1;

FIG. 9 is an explanatory chart of an image showing a traffic signal as an example of the symbol image data of Example 1, in which FIG. 9A illustrates a traffic signal as an example of the medium resolution symbol image data while FIG. 9B illustrates a traffic signal as an example of the low resolution symbol image data;

FIG. 10 is an explanatory chart of an image displayed on the information display screen using the symbol image data of Example 1, in which FIG. 10A illustrates an image that a low resolution mobile terminal displays using low resolution symbol image data, while FIG. 10B illustrates an image that a medium resolution mobile terminal displays using low resolution symbol image data, and FIG. 10C illustrates an image that the medium resolution mobile terminal displays using medium resolution symbol image data;

FIG. 11 is a functional block diagram of a mobile terminal in the image data transmitting/receiving system of Example 2, which corresponds to FIG. 2 of Example 1;

FIG. 12 is a functional block diagram of a server in the image data transmitting/receiving system of Example 2, which corresponds to FIG. 4 of Example 1;

FIG. 13 is a flow chart of a symbol image data transmitting/receiving processing by the mobile terminal in Example 2, which is a flow chart of a subroutine corresponding to FIG. 6 of Example 1;

FIG. 14 is a main flow chart of a map data delivery application program provided for the server in the image data transmitting/receiving system of Example 2, which corresponds to FIG. 7 of Example 1;

FIG. 15 is a functional block diagram of a mobile terminal in the image data transmitting/receiving system of Example 3, which corresponds to FIG. 2 of Example 1 and FIG. 11 of Example 2;

FIG. 16 is a functional block diagram of a server in the image data transmitting/receiving system of Example 3, which corresponds to FIG. 4 of Example 1 and FIG. 12 of Example 2;

FIG. 17 is a main flow chart of a map display application program provided for the mobile terminal in the image data transmitting/receiving system of Example 3, which corresponds to FIG. 5 of Example 1; and

FIG. 18 is a main flow chart of a map data delivery application program provided for the server in the image data transmitting/receiving system of Example 3, which corresponds to FIG. 7 of Example 1 and FIG. 14 of Example 2.

### DETAILED DESCRIPTION OF THE PREFERRED EMBODIMENTS

The concrete examples of the preferred embodiments according to the present invention will now be described with reference to the accompanying drawings. The present invention however is not confined to the following examples.

### EXAMPLE 1

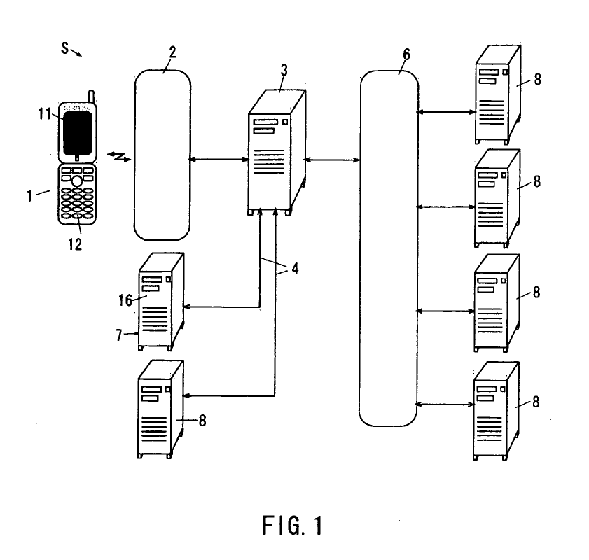

FIG. 1 is an explanatory chart of the image data transmitting/receiving system of Example 1 relating to the present invention;

In FIG. 1, the image data transmitting/receiving system (S) of Example 1 comprises a mobile phone 1 as a mobile terminal that a user can carry on his person. The mobile phone 1 is connected to a data communication system 3 of a mobile phone business through a mobile phone network 2 and the data communication system 3 is connected to a map data delivery server 7 and information delivery servers 8 of other information delivery businesses (contents providers, application service providers) through dedicated lines 4 and the Internet 6.

The mobile phone 1 has an information display screen 11 on which images are displayed, input keys 12 with which a user makes various inputs, and a storage device (recording medium) for programs, etc. recorded therein. The mobile phone 1 of Example 1 also has a built-in GPS (Global Positioning System) which can measure the current position of the mobile phone three-dimensionally.

The map data delivery server 7 has a server body 16 and a display (not illustrated), an input device such as a keyboard and a mouse (not illustrated), a hard disk drive (recording medium, not illustrated), an optical drive such as a CD drive (not illustrated), and so forth.

Description of the Controller of the Mobile Phone 1

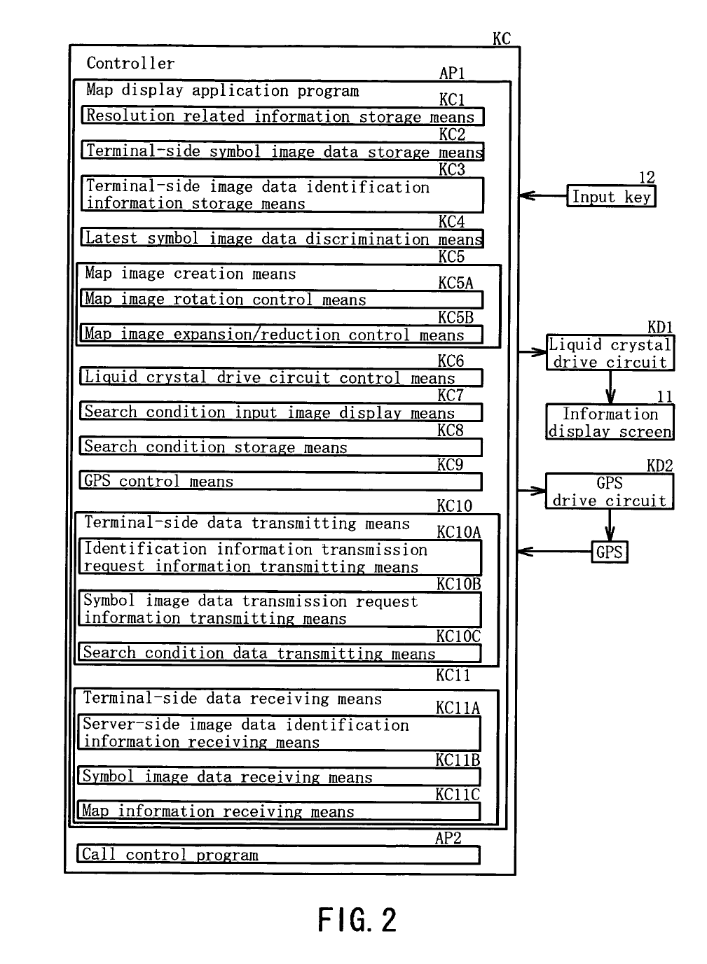

FIG. 2 is a functional block diagram of a mobile terminal in the image data transmitting/receiving system referred to in FIG. 1;

In FIG. 2, the controller KC of the mobile phone 1 includes an I/O (input/output interface) that inputs/outputs signals to/from the outside and adjusts input/output signal levels, a ROM (read only memory) in which programs and data and so forth are stored for executing necessary processing, a RAM (random access memory) that stores necessary data temporarily, a CPU (central processing unit) that executes processing according to the programs stored in the ROM, etc., and a microcomputer having clock oscillators and so forth. The controller KC having the above construction is capable of realizing various functions by executing the programs stored in the ROM and so forth.

Signal Input Components Connected to the Controller KC of the Mobile Phone

The controller KC of the mobile phone 1 has signals inputted from the input key 12, GPS device, and other signal input components.

The input key 12 detects that these signals are inputted by a user, and inputs the detected signals to the controller KC.

The GPS device measures the global position of the mobile phone 1 from the arrival time of a time signal wave emitted from the satellite and so forth, in response to the input signal for starting the position measurement, and inputs the position measurement result to the controller KC.

Control Components Connected to the Controller KC of the Mobile Phone

The controller KC of the mobile phone 1 is connected to a liquid crystal drive circuit KD1, a GPS drive circuit KD2, a power supply circuit (not illustrated), and the other control parts, and outputs operational control signals for these components.

The liquid crystal drive circuit KD1 controls the on-off operation of the display electrodes of the liquid crystal panel, and displays images on the information display screen 11.

The GPS drive circuit KD2 outputs the signal for starting the position measurement to the GPS device to drive.

Function of the Controller KC of the Mobile Phone

The controller KC of the mobile phone 1 has a map display application program AP1 such as navigation software and so forth, a call control program AP2, and other programs. It also has a function (control means) that outputs control signals to the control components, while executing the processing in response to the output signals from the signal output components. The function (control means) of the map display application program AP1 provided for the controller KC will now be described. The call control program AP2 is a program to control calls on the mobile phone 1, and many conventionally known techniques are applicable to this call control program. Detailed descriptions will be omitted here.

KC1: Resolution Related Information Storage Means

The resolution related information storage means KC1 stores resolution related information pertinent to the resolution of the information display screen 11. The resolution related information storage means KC1 of Example 1 retains the horizontal dot number X (320 dots, for example) of the information display screen 11. Here, it is possible to use information pertinent to the resolution, such as picture elements (1 million pixels, for example), vertical dot number Y (240 dots, for example) of the information display screen, resolution (72 dot per inch [dpi]), for example), and classification of resolution (VGA, QVGA, for example).

KC2: Terminal-Side Symbol Image Data Storage Means

The terminal-side symbol image data storage means KC2 is used in creating map images (display images) arranged on the information display screen 11, and stores data (symbol image data) constituting images (map symbol images, for example) of specific graphic symbols forming part of the map images. The symbol image data of Example 1 include not only map symbol images, but also images that represent specific affiliated gas stands, for example, and images that distinguish franchised convenience stores and restaurants, affiliated banks, and so forth. The terminal-side symbol image data storage means KC2 of Example 1 retains, in addition to the data of the map symbol images and so forth, pallet image data constituting images of roads and railroads as symbol image data. Further, terminal-side symbol image data storage means KC2 of Example is able to store the data of icon images displayed on the map images, in addition to the data of map symbol images and so forth.

Furthermore, when the mobile phone 1 receives the symbol image data (map symbol image data and pallet image data) transmitted from the map data delivery server 7, the terminal-side symbol image data storage means KC2 stores the received symbol image data, and updates the symbol image data already in store.

KC3: Terminal-Side Image Data Identification Information Storage Means

The terminal-side image data identification information storage means KC3 stores terminal-side image data identification information constituting identification information of the symbol image data stored in the terminal-side symbol image data storage means KC2. The terminal-side image data identification information storage means KC3 of Example 1 retains version information (version 1.1, for example) of the symbol image data as terminal-side image data identification information. Here, it is also possible to use updated date and time data indicating the date and time when the symbol image data are updated (first of October, 2003, or Jan. 10, 2003, for example) as terminal-side image data identification information, and arbitrary identification information such as serial numbers. And, when the symbol image data have been updated, the terminal-side image data identification information, together with the symbol image data, is updated as symbol image data identification information for transmission.

KC4: Latest Symbol Image Data Discrimination Means

The latest symbol image data discrimination means KC4 discriminates whether or not the symbol image data stored in the mobile phone 1 are the latest data on the basis of server-side image data identification information transmitted from the map data delivery server 7 (identification information of the symbol image data stored in the server 7). The latest symbol image data discrimination means KC4 of Example 1 discriminates on the basis of whether the number allotted to the version information is the same or not. In other words, if the server-side symbol image data are always the latest, and the number allotted to the version information after being updated is always larger than that of the version information before being updated and the number allotted to the version information is the same, the symbol image data in the mobile terminal 1 will be judged as being the latest. If the number allotted to the version information is not the same (namely, if the number of the terminal-side image data identification information is smaller), the symbol image data in the mobile terminal 1 will be judged as not being the latest.

KC5: Map Image Creation Means

The map image creation means KC5, which includes a map image rotation control means KC5A and a map image expansion/reduction control means KC5B, creates map images displayed on the information display screen 11 on the basis of the map information transmitted from the map data delivery server 7 and the map symbol images (symbol image data). Here, the map information of Example 1 includes information specifying map symbol images or pallet images (symbol image specification information), and information specifying a location where a map symbol image is situated or a range within which a pallet image is plotted (location information). Here, the symbol image specification information and the location information constitute the map information (the so-called vector map data).

KC5A: Map Image Rotation Control Means

The map image rotation control means KC5A rotates map images in accordance with a user's input by means of the input key 12. The map image rotation control means KC5A of Example 1 creates the map images after rotation in accordance with a user's input.

KC5B: Map Image Expansion/Reduction Control Means

The map image expansion/reduction control means KC5B expands or reduces map images in accordance with a user's input through the input key 12. The map image expansion/reduction control means KC5B of Example 1 creates the map images after expanded or reduced, in accordance with a user's input.

KC6: Liquid Crystal Drive Circuit Control Means

The liquid crystal drive circuit control means KC6 displays map images created by the map image creation means KC5 on the information display screen 11 by means of the liquid crystal drive circuit KD11.

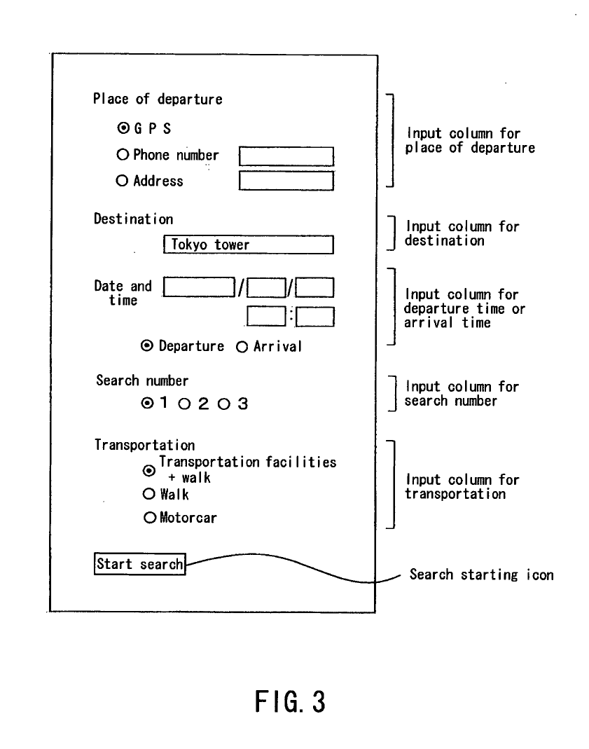

FIG. 3 is an example of a search condition input image displayed on the information display screen of the mobile phone of Example 1.

KC7: Search Condition Input Screen Display Means

The search condition input screen display means KC7 displays the search condition input image (refer to FIG. 3) on the information display screen 11, and with which a user inputs conditions of the route to be searched (starting point and destination, etc.) upon activating the navigation software (map display application program). The search condition input image shown in FIG. 3 includes columns for inputting conditions of a starting point, destination, starting date and time, arrival date and time, route search number, and route search number, and search starting icon transmitted to the map data delivery server 7.

KC8: Search Condition Storage Means

The search condition storage means KC8 stores the conditions given to the search condition input image based on a user's input (refer to FIG. 3).

KC9: GPS Control Means

The GPS control means KC9 controls to drive the GPS device by way of the GPS drive circuit KD2, and causes the GPS device to measure the current position of the mobile phone 1 with a specific input signal or within a specific time interval. That is, while the navigation function is executed by means of the map images displayed on the information display screen 11, the current position is measured within a specific time interval (every 5 seconds, for example). Thus, if the starting point input column of the search conditions is set to ‘GPS’ when the search conditions are transmitted to the server, the current position of the mobile phone 1 is measured by the GPS device and information on current position is also transmitted to the server.

KC10: Terminal-Side Data Transmitting Means

The terminal-side data transmitting means KC10, which includes an identification information transmission request information transmitting means KC10A, a symbol image data transmission request information transmitting means KC10B, and a search condition data transmitting means KC10C, transmits specific data to the map data delivery server 7.

KC10A: Identification Information Transmission Request Information Transmitting Means

The identification information transmission request information transmitting means KC10A transmits server-side image data identification information transmission request information for requesting the map data delivery server 7 to transmit server-side image data identification information constituting identification information of the symbol image data stored in the server 7, before creating images displayed on the information display screen 11. The identification information transmission request information transmitting means KC10A of Example 1 transmits the server-side image data identification information transmission request information, on starting the navigation software.

KC10B: Symbol Image Data Transmission Request Information Transmitting Means

The symbol image data transmission request information transmitting means KC10B transmits symbol image data transmission request information requests for transmission of the symbol image data stored in the server and the resolution related information to the server. The symbol image data transmission request information transmitting means KC10B of Example 1 transmits the resolution related information as well as the symbol image data transmission requests when the latest symbol image data discrimination means KC4 has determined that the symbol image data stored in the mobile phone 1 are not the latest data.

KC10C: Search Condition Data Transmitting Means

The search condition data transmitting means KC10C transmits map information transmission requests to transmit to the map data delivery server 7, data corresponding to the search conditions (starting point, destination, etc.) stored in the search condition storage means KC8 and the map information according to the search conditions inputted, when the search starting icon is selected from among the search condition input images. The search condition data transmitting means KC10C of Example 1 transmits the search condition data of the current position of the mobile phone 1 and the map information transmission request information to the server 7 as needed, when a user travels and conducts navigation using the GPS and the mobile phone 1 is about to move outside the range of the map images stored in the mobile phone 1. In Example 1, when a map image that the map image creation means KC5 is capable of making becomes smaller than the size of the information display screen 11, with the user's current position located at the center of the screen, the map image is adjudged as being outside the range.

KC11: Terminal-Side Data Receiving Means

The terminal-side data receiving means KC11, which includes a server-side image data identification information receiving means KC11A, a symbol image data receiving means KC11B, and a map information receiving means KC11C, receives and stores the data transmitted from the map data delivery server 7.

KC11A: Server-Side Image Data Identification Information Receiving Means

The server-side image data identification information receiving means KC11A receives the server-side image data identification information transmitted from the map data delivery server 7, in response to the server-side image data identification information transmission request.

KC11B: Symbol Image Data Receiving Means

The symbol image data receiving means KC11B receives the symbol image data transmitted from the map data delivery server 7, in response to the symbol image data transmission request.

KC11C: Map Information Receiving Means

The map information receiving means KC11C receives the map information (vector map data) transmitted from the map data delivery server 7, in response to the search condition data request. The map information receiving means KC11C of Example 1 receives and stores the map information which is composed of unit map data, using the same technique disclosed in Japanese Patent JP-2003-214860-A.

Description of the Controller of the Map Data Delivery Server 7

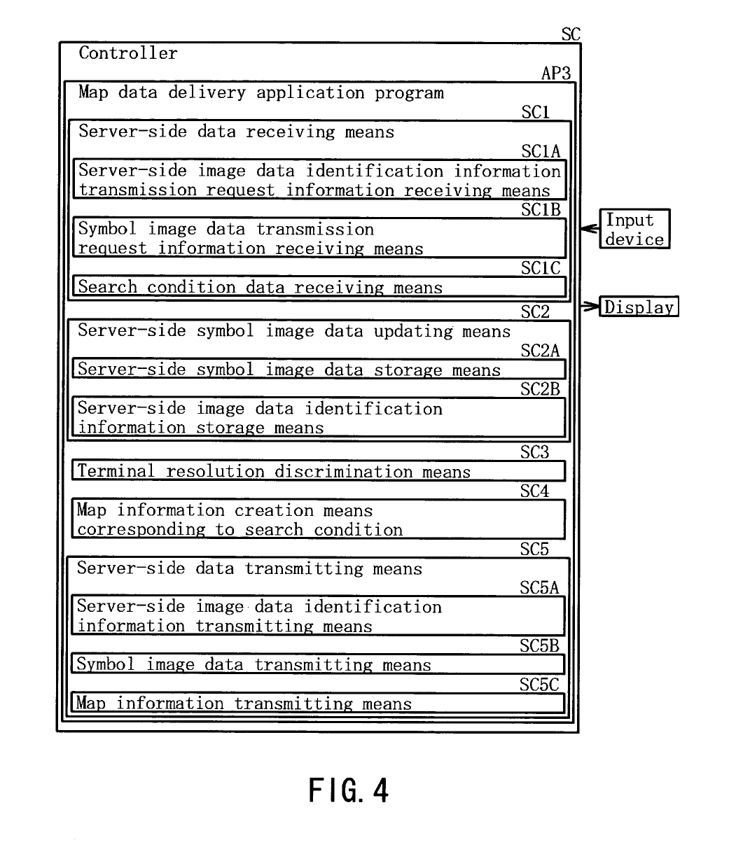

FIG. 4 is a functional block diagram of the server in the image data transmitting/receiving system shown in FIG. 1.

In FIG. 4, the controller SC of the map data delivery server 7 includes an I/O (input/output interface) that inputs/outputs signals to/from the outside and adjusts input/output signal levels, a ROM (read only memory, recording medium such as a hard disk) in which programs and data and so forth are stored for executing necessary processing, a RAM (random access memory) that temporarily stores necessary data, a CPU (central processing unit) that executes processing according to the programs stored in the ROM, etc., and a microcomputer having clock oscillators and so forth. The controller SC having the above construction capable of realizing various functions by executing the programs stored in the ROM and so forth.

(Signal Input Components Connected to the Controller SC)

The controller SC of the map data delivery server 7 is equipped with signals inputted from input devices such as a keyboard and a mouse, and other signal input components.

The input devices detect that these signals are inputted by a user, and input the detected signals to the controller SC.

(Control Components Connected to the Controller SC of the Server)

The controller SC of the map data delivery server 7 is connected to a display, a power supply circuit not illustrated, and other control components, and outputs operational control signals for these.

The display images corresponding to the user's operations are arranged on the display.

Function of the Controller SC of the Server

The controller SC of the map data delivery server 7 has a map data delivery application program AP3 that executes processing of the data transmitted from the navigation software (map display application program AP1) provided for in the mobile phone 1, and other programs. It also has a function (control means) of outputting control signals to the control components, while executing the processing function in response to the output signals originating from the signal output components. The function (control means) of the map data delivery application program AP3 of the controller SC will be described hereafter.

SC1: Server-Side Data Receiving Means

The server-side data receiving means SC1, which includes a server-side image data identification information transmission request information receiving means SC1A, a symbol image data transmission request information receiving means SC1B, and a search condition data receiving means SC1C, receives and stores the information/data transmitted from the mobile phone 1.

SC1A: Server-Side Image Data Identification Information Transmission Request Information Receiving Means

The server-side image data identification information transmission request information receiving means SC1A receives the server-side image data identification information transmission requests transmitted from the mobile phone 1.

SC1B: Symbol Image Data Transmission Request Information Receiving Means

The symbol image data transmission request information receiving means SC1B receives the symbol image data transmission requests and the resolution related information which are transmitted from the mobile phone 1.

SC1C: Search Condition Data Receiving Means

The search condition data receiving means SC1C receives the search condition data transmitted from the mobile phone 1.

SC2: Server-Side Symbol Image Data Updating Means

The server-side symbol image data updating means, which includes a server-side symbol image data storage means SC2A and a server-side image data identification information storage means SC2B, updates data inputted through the input devices, data recorded on a recording medium such as a CD, and symbol image data by way of a network as well as image data identification information.

SC2A: Server-Side Symbol Image Data Storage Means

The server-side symbol image data storage means SC2A stores the symbol image data in correspondence with the resolution of the information display screen of the mobile terminal. The server-side symbol image data storage means SC2A of Example 1 stores symbol image data for high resolution, symbol image data for medium resolution, and symbol image data for low resolution in correspondence with the horizontal dot number X of the information display screen 11 of the mobile phone 1. In Example 1, the map symbol images of the symbol image data for high resolution are created with 32 dots by 32 dots, the map symbol images of the symbol image data for medium resolution with 20 dots by 20 dots, and the map symbol images of the symbol image data for low resolution with 12 dots by 12 dots.

SC2B: Server-Side Image Data Identification Information Storage Means

The server-side image data identification information storage means SC2B stores server-side image data identification information constituting identification information of the symbol image data stored in the server-side symbol image data storage means SC2A. In Example 1, the server-side image data identification information is stored in the same manner as the terminal-side image data identification information in the server-side image data identification information storage means SC2B as the version information.

SC3: Terminal Resolution Discrimination Means

The terminal resolution discrimination means SC3 discriminates symbol image data transmitted to the mobile terminal on the basis of the resolution related information received. In Example 1, the terminal resolution discrimination means SC3 discriminates whether the resolution capability of the information display screen 11 of the mobile phone 1 lies is of high resolution (horizontal dot number X≧400), medium resolution (200≦dot number X<400), or low resolution (dot number X<200), and discriminates the symbol image data transmitted in correspondence with the discriminated resolution.

SC4: Map Information Creation Means Corresponding to Search Conditions

The map information creation means corresponding to search condition SC4 creates map information (vector map data) in correspondence with the search conditions transmitted from the mobile phone 1. The map information creation means SC4 of Example 1 searches a navigating route in correspondence with the conventionally known search conditions (refer to Japanese Patent JP-2003-214860-A, for example), and reads the map information in the area corresponding to the searched route from the map data delivery server 7 or the other information delivery servers 8.

SC5: Server-Side Data Transmitting Means

The server-side data transmitting means SC5, which includes a server-side image data identification information transmitting means SC5A, a symbol image data transmitting means SC5B, and a map information transmitting means SC5C, transmits specific data (information) to the mobile phone 1.

SC5A: Server-Side Image Data Identification Information Transmitting Means

The server-side image data identification information transmitting means SC5A transmits the server-side image data identification information upon receiving the server-side image data identification information transmission requests.

SC5B: Symbol Image Data Transmitting Means

The symbol image data transmitting means SC5B transmits symbol image data which is discriminated by the terminal resolution discrimination means SC3, in correspondence with the resolution of the information display screen of the mobile phone 1. That is, if the resolution capability of the information display screen of the mobile phone 1 is discriminated as being of high resolution, the symbol image data for high resolution will be transmitted, and if it is discriminated as being of low resolution, the symbol image data for low resolution will be transmitted.

SC5C: Map Information Transmitting Means

The map information transmitting means SC5C transmits to the mobile phone 1 map information including: symbol image specifying information that specifies the symbol images (map symbol images or pallet images), and location information that specifies locations or area where the specified symbol images are laid out.

Description of Flow Charts

Description of the Main Flow Chart in the Mobile Terminal

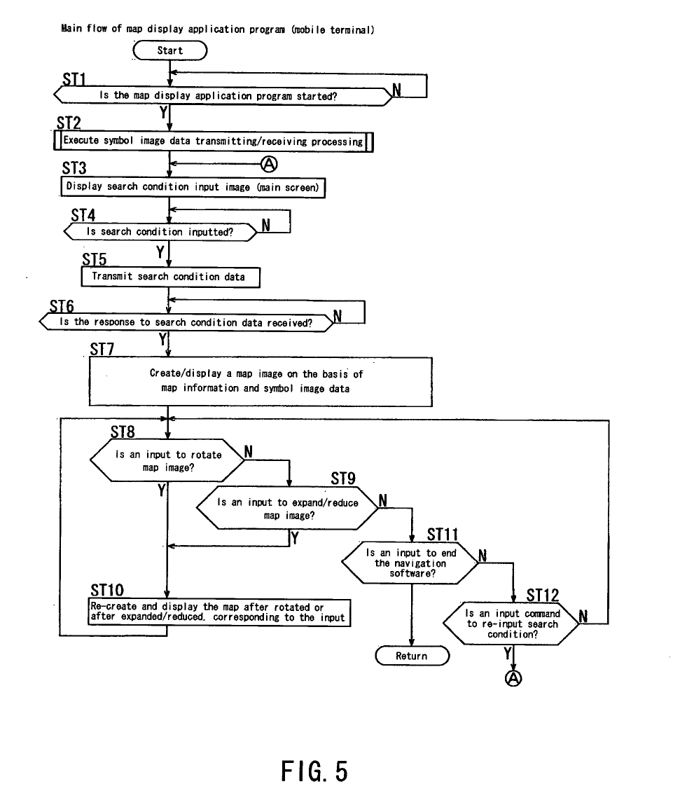

FIG. 5 is the main flow chart of the map display application program AP1 provided for in the mobile terminal in the image data transmitting/receiving system of Example 1.

The processing pertaining to each step (ST) of the flow chart in FIG. 5 is executed according to the map display application program AP1 stored in the ROM of the controller KC and so forth, and in parallel with other various processing functions of the mobile phone 1.

The flow chart illustrated in FIG. 5 starts with the supply of power made to the mobile phone 1.

ST1 in FIG. 5 discriminates whether the navigation software (map display application program AP1) has started and if Yes (Y), processing proceeds to ST2, and if No (N), ST1 is repeated.

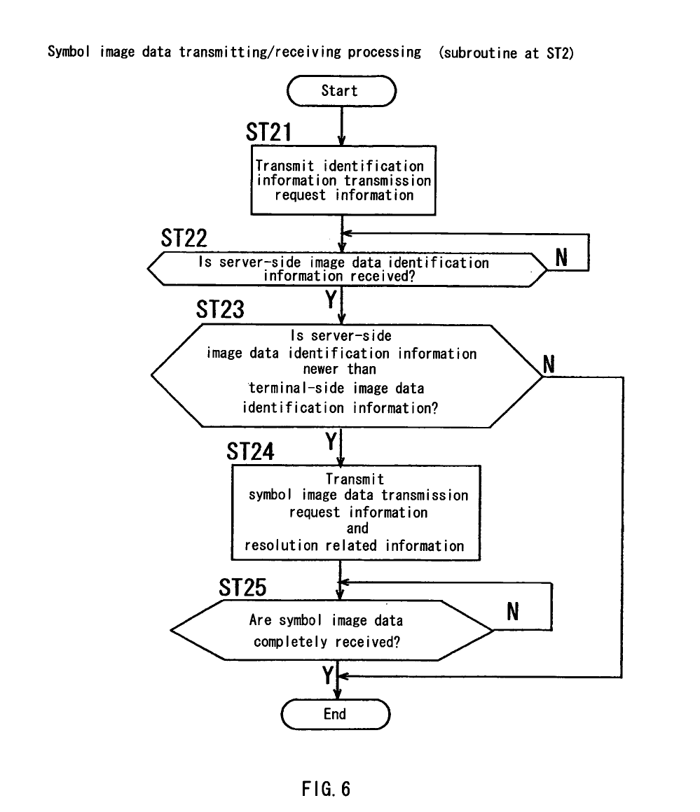

ST2 discriminates whether the symbol image data in the mobile phone 1 are the latest data, (namely, whether or not the symbol image data stored in the server 7 are updated). If not, ST2 executes the symbol image data transmitting/receiving processing that receives the symbol image data from the server 7 (refer to the subroutine in FIG. 6, described later). Thereafter, processing proceeds to ST3.

ST3 displays the search condition input image (main screen) as shown in FIG. 3 on the information display screen 11. Thereafter, processing proceeds to ST4.

ST4 inputs the search conditions on the search condition display screen based on the user's input, and discriminates whether or not the search starting icon has been selected. If Yes (Y), processing proceeds to ST5 and if No (N), ST4 is repeated.

ST5 transmits the data of the inputted search conditions to the map data delivery server 7. Thereafter, processing proceeds to ST6.

ST6 discriminates whether or not the search condition response data (namely, map information) are received, constituting the response corresponding to the search condition data transmitted to the map data delivery server 7. If Yes (Y), processing proceeds to ST7, and if No (N), ST6 is repeated.

ST7 creates a map image on the basis of the received map information and the symbol images stored in the terminal-side symbol image data storage means KC2, and displays it on the information display screen 11. Thereafter, processing proceeds to ST8.

ST8 discriminates whether or not there is an input command to rotate the map image. If No (N) processing proceeds to ST9, and if Yes (Y), processing proceeds to ST10.

ST9 discriminates whether or not there is an input command to expand/reduce the map image. If Yes (Y), processing proceeds to ST10, and if No (N), processing proceeds to ST11.

ST10 creates the map image after rotation or the map image after expansion/reduction on the basis of the map information and the symbol image data, and displays it on the information display screen 11. Thereafter, processing reverts to ST8.

ST11 discriminates whether or not there is an input command to terminate the navigation software (map display application program AP1) by means of the input key 12. If No (N), processing proceeds to ST12 and if Yes (Y), processing reverts to ST11.

ST12 discriminates whether or not there is an input command to re-input the search condition by means of the input key 12. If Yes (Y), processing reverts to ST3, and displays the search condition input image on the information display screen 11. If No (N), processing reverts to ST8.

Description of the Flow Chart of the Symbol Image Data Transmitting/Receiving Process (Subroutine ST2)

FIG. 6 pertains to the flow chart of symbol image data transmitting/receiving function executed by the mobile terminal of Example 1, and referred to as the subroutine ST2 in the flow chart shown in FIG. 5.

ST21 in FIG. 6 transmits the identification information transmission requests to transmit the server-side image data identification information to the map data delivery server 7, and processing proceeds to ST22.

ST22 discriminates whether or not the server-side image data identification information is received. If Yes (Y), processing proceeds to ST23 and if No (N), ST22 is repeated.

ST23 discriminates whether or not the received server-side image data identification information is newer than the terminal-side image data identification information stored in the terminal-side image data identification information storage means KC3. In particular, ST23 discriminates whether or not the terminal-side version information has the same value as that of the server-side version information. If Yes (Y), processing proceeds to ST24 and if No (N), the symbol image data transmitting/receiving processing referred to in FIG. 6 is terminated and processing proceeds to the above-mentioned ST3 in FIG. 5.

ST24 transmits the symbol image data transmission requests and the resolution related information to the map data delivery server 7 and thereafter, processing moves to ST25.

ST25 discriminates whether the symbol image data transmitted from the map data delivery server 7 in correspondence with the resolution of the information display screen 11 of the mobile phone 1 are completely received or not. If No (N), ST25 is repeated and if Yes (Y), the symbol image data transmitting/receiving processing referred to in FIG. 6 are terminated and processing proceeds to the above-mentioned ST3 in FIG. 5.

Description of the Main Flow Chart in the Server

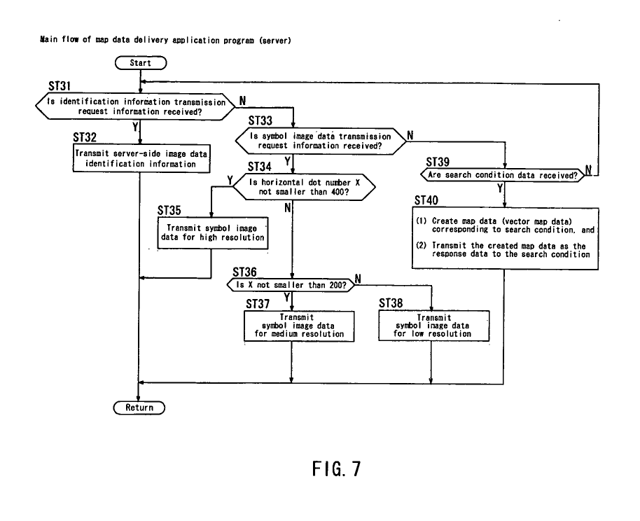

FIG. 7 illustrates the main flow chart of the map data delivery application program AP3 provided for in the server in the image data transmitting/receiving system of Example 1.

The processing pertaining to each step (ST) in the flow chart in FIG. 7 is executed according to the map data delivery application program AP3 stored in the ROM of the controller SC of the server 7 and so forth, and in parallel with other various processing by the server 7.

The flow chart illustrated in FIG. 7 starts with the activation of the map data delivery application program AP3 in the server 7.

ST31 in FIG. 7 discriminates whether the identification information transmission request information transmitted from the mobile phone 1 is received or not (refer to ST21 in FIG. 6). If Yes (Y), processing proceeds to ST32 and if No (N), processing proceeds to ST33.

ST32 transmits the server-side image data identification information constituting the response to the identification information transmission request information, and thereafter, processing reverts to ST31.

ST33 discriminates whether the symbol image data transmission request information transmitted from the mobile phone 1 is received or not (refer to ST24 in FIG. 6). If Yes (Y), processing proceeds to ST34 and if No (N), processing proceeds to ST39.

ST34 discriminates whether the value of the horizontal dot number X is equal to or larger than 400, which represents the resolution related information simultaneously received with the symbol image data transmission request information. If Yes (Y), processing proceeds to ST35 and if No (N), processing proceeds to ST36.

In ST35, if the resolution of the information display screen 11 of the mobile phone 1 is indicated as high resolution (not smaller than 400 dots), the symbol image data of high resolution is transmitted to the mobile phone 1. Thereafter, processing reverts to ST31.

ST36 discriminates whether the value of the horizontal dot number X is equal to or larger than 200. If Yes (Y), processing proceeds to ST37 and if No (N), processing proceeds to ST38.

In ST37, if the resolution of the information display screen 11 of the mobile phone is indicated as medium resolution (200-400 dots), the symbol image data of medium resolution is transmitted to the mobile phone 1. Thereafter, processing reverts to ST31.

In ST38, if the resolution of the information display screen 11 of the mobile phone is indicated as low resolution (smaller than 200 dots), the symbol image data of medium resolution is transmitted to the mobile phone 1. Thereafter, processing reverts to ST31.

ST39 discriminates whether the search condition data transmitted from the mobile phone 1 are received or not (refer to ST5 in FIG. 5). If Yes (Y), processing proceeds to ST40 and if No (N), processing reverts to ST31.

In ST40, the following steps (1), (2) take place and thereafter, processing reverts to ST31.
(1) creating the map information (vector map data) corresponding to the search condition, and
(2) transmitting the created map information as the response data to the search condition, to the mobile phone 1 that transmitted the search condition data.
   Function of Example 1

In the image data transmitting/receiving system S of Example 1 having the above-described construction, whether or not the symbol image data stored in the mobile phone 1 are the latest data is discriminated upon activation of the navigation software. When it has been determined that the data are not the latest, the resolution related information pertinent to the resolution of the information display screen 11 of the mobile phone 1 is transmitted, and the symbol image data corresponding to the resolution are transmitted from the server 7. And, when the map information corresponding to the search condition inputted by the user is received from the server 7, the map image is created on the basis of the map information and the latest symbol image data.

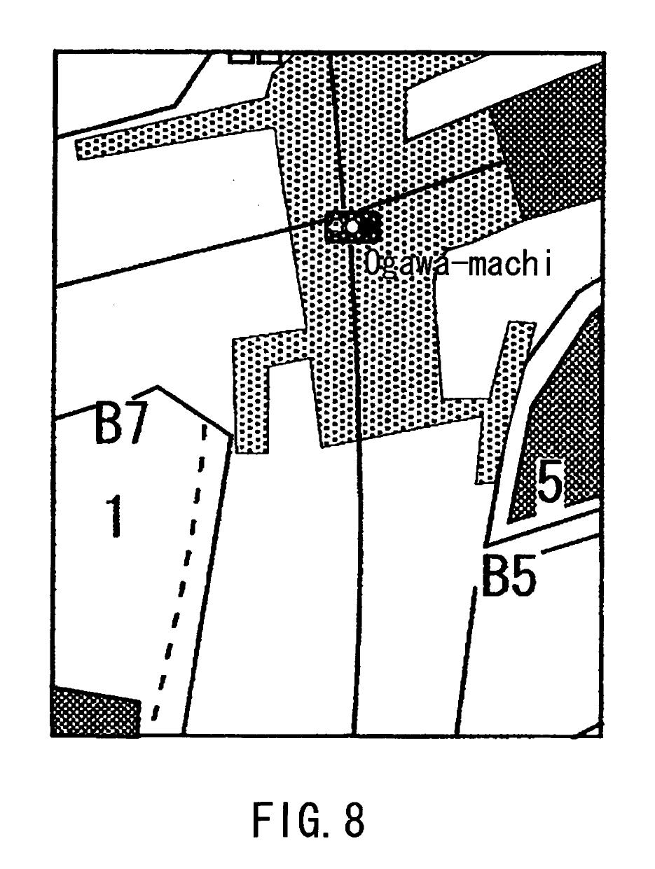

FIG. 8 is an example of a map image displayed on the information display screen of the mobile terminal of Example 1.

By way of example, the map image data as shown in FIG. 8 is created when the map information transmitted from the server 7 includes information for displaying the map symbol image indicating a traffic signal at a specific coordinate on the central upper area of a unit map, information for locating the pallet image data indicating roads from top to bottom and from the upper right end to the lower left end on the unit map, and information for locating the pallet image data indicating an underground passage on the central upper area of the unit map, The map image shown in FIG. 8 includes the image indicating a way in/out to/from the underground passage (‘B5’, ‘B7’ in FIG. 8), and an image indicating the town's name and address, etc, and these are displayed in the created map image.

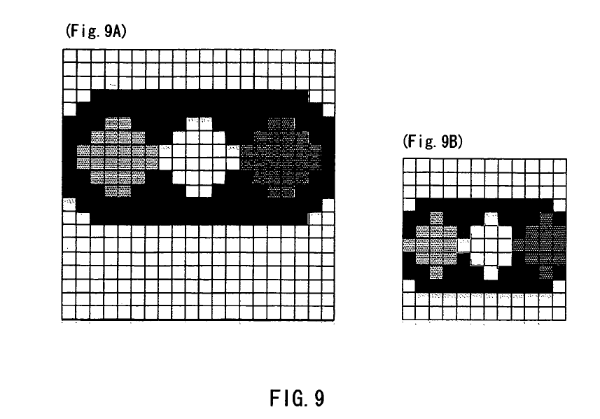

FIG. 9 is an explanatory chart of an image showing a traffic signal as an example of the symbol image data of Example 1, in which FIG. 9A illustrates a traffic signal representing an example of medium resolution symbol image data, while FIG. 9B illustrates a traffic signal representing an example of low resolution symbol image data.

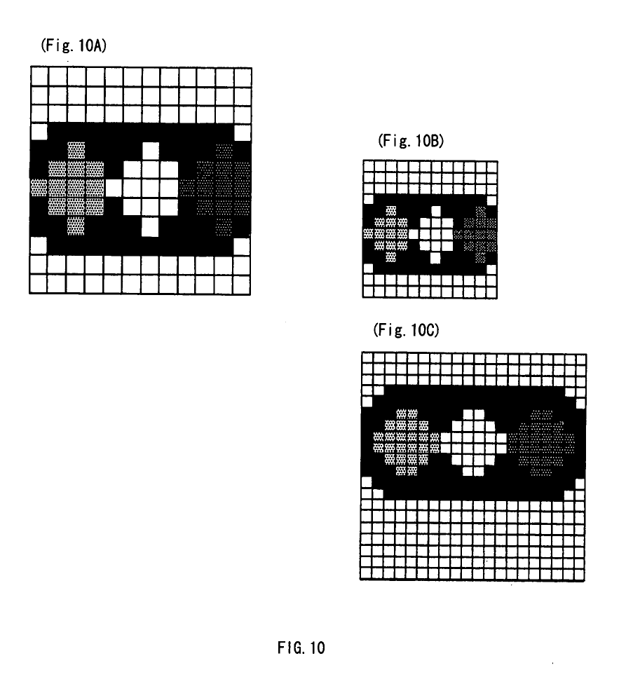

FIG. 10 is an explanatory chart of an image displayed on the information display screen using the symbol image data of Example 1, in which FIG. 10A illustrates an image that a mobile terminal of low resolution capability displays using low resolution symbol image data, while FIG. 10B illustrates an image that a mobile terminal of medium resolution capability displays using low resolution symbol image data, and FIG. 10C illustrates an image that a mobile terminal of medium resolution displays using medium resolution symbol image data.

In the map symbol image stored in the server 7 of Example 1 in FIG. 9, as shown in FIG. 9A, the map symbol image illustrating a medium resolution traffic signal is created with 20 dots by 20 dots, and as shown in FIG. 9B, the map symbol image illustrating a low resolution traffic signal is created with 12 dots by 12 dots.

In the conventional technique shown in FIG. 10A displaying the map symbol image (12 dots by 12 dots) illustrating the low resolution traffic signal, which is intended to be displayed with a specific size on a low resolution information display screen 11, and also on a medium resolution information display screen 11 provided for the mobile phone 1, the map symbol image becomes smaller as shown in FIG. 10B, and viewing thereof becomes difficult, because the size of one dot on the medium resolution information display screen 11 is smaller than that of the low resolution information display screen 11.

On the other hand, when the image data transmitting/receiving system S of Example 1 displays the medium resolution map symbol image on the information display screen 11 with medium resolution capability, the total size of the displayed map symbol image is of the same size as that of the low resolution map symbol image displayed on the information display screen 11 with low resolution capability, as shown in FIG. 10C, and it would not be difficult therefore the view the image. In addition, since the dots are finer, map images including map symbol images become high-definition in resolution.

Therefore, in the image data transmitting/receiving system S of Example 1, when the map images to be displayed on the information display screen 11 of the mobile phone 1 are created, the symbol image data (map symbol image data and pallet image data) corresponding to the resolution are used. As a result, it becomes possible to display symbol images of appropriate sizes on the map images arranged on the information display screen 11 corresponding to the resolution of the information display screen 11. Therefore, even where conventionally low resolution symbol image data are displayed on a high resolution information display screen 11, the problem of symbol images becoming excessively small as to pose viewing problems for the user can be solved. And, since appropriately sized symbol images corresponding to the resolution of the information display screen 11 are used, the problem of medium resolution symbol image data or high resolution symbol image data displayed on the information display screen 11 of low resolution capability becoming too large to be displayed as to make viewing of map images (display images) difficult can be avoided.

Further, in the image data transmitting/receiving system S of Example 1, whether the symbol image data stored in the terminal-side symbol image data storage means KC2 of the mobile phone 1 are the latest data is discriminated by the latest symbol image data discrimination means KC4. It is only when the symbol image data in the mobile phone 1 have been determined as not being the latest by way of up-dating the symbol image data stored in the server-side symbol image data storage means SC2A and so forth, that the symbol image data are transmitted from the server 7 to the mobile phone 1. As a result, in contrast to the case where the symbol image data is transmitted every time without a determination being made that it is the latest, the image data transmitting/receiving system S of Example 1 system succeeds in effecting reduction of the quantity of data transmitted and received, and reduction of communication cost, while preventing communication jams. Further, since the mobile phone 1 discriminates whether the symbol image data are the latest data, the load on the server 7 will be reduced.

Further, in the image data transmitting/receiving system S of Example 1, the mobile phone 1 creates the map images on the basis of the map information (vector map data) transmitted from the map data delivery server 7. Therefore, the map images can be created with the map symbol images corresponding to the resolution after being rotated, expanded, or reduced. Thus, after the map images are rotated, the map symbol images can be displayed in a slanting direction in relation to the information display screen 11, making the displayed images easy to view. Further, in case the map images are expanded or reduced, the size of the map symbol images of the expanded or reduced map images is not affected, and the map symbol images corresponding to the resolution are displayed on the map images as having appropriate sizes corresponding to the resolution of the information display screen 11. Therefore, the problem of the map images becoming difficult to view does not arise.

### EXAMPLE 2

The image data transmitting/receiving system S of Example 2 of the present invention will be described next. In the description of Example 2, the same components corresponding to the components of Example 1 are assigned the same symbols, and detailed description thereof will thus be omitted.

Although Example 2 is constructed in the same manner as Example 1, it differs from Example 1 in regard to the following points:

Description of the Controller of the Mobile Phone 1

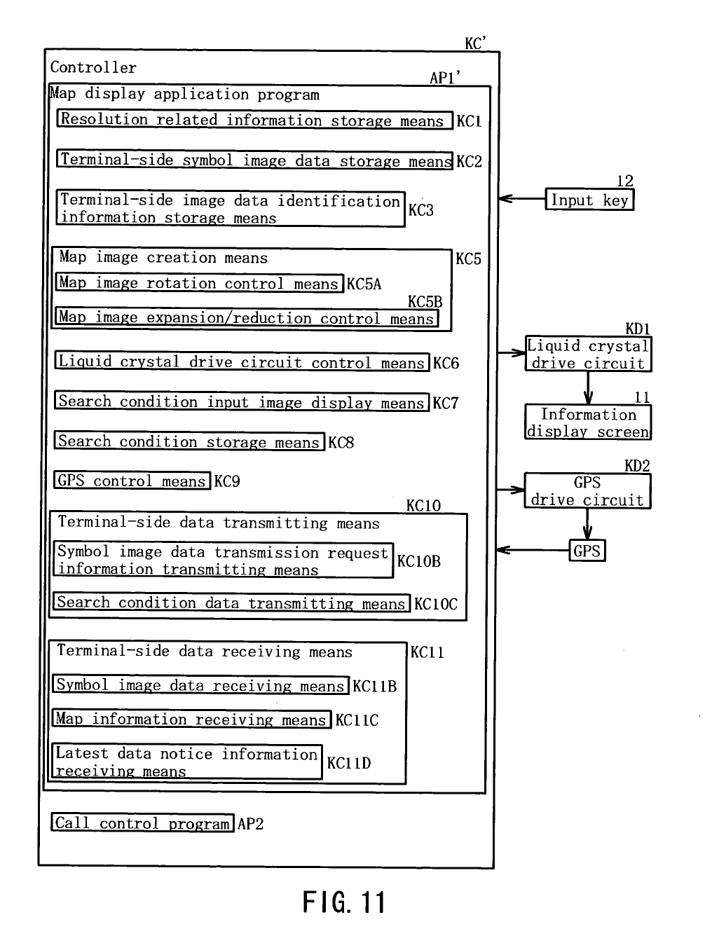

FIG. 11, which corresponds to FIG. 2 of Example 1, is a functional block diagram of a mobile terminal in the image data transmitting/receiving system of Example 2. In FIG. 11, in the map display application program AP1′ provided for the controller KC′ of the mobile phone 1 in Example 2, the latest symbol image data discrimination means KC4 referred to in the map display application program AP1 of Example 1 is not included. And, the identification information transmission request information transmitting means KC10A of the terminal-side data transmitting means KC10 and the server-side image data identification information receiving means KC11A of the terminal-side data receiving means KC11 likewise are not included.

Further, the terminal-side data receiving means KC11 of Example 2 is provided with the latest data notice information receiving means KC11D.

KC11D: Latest Data Notice Information Receiving Means

The latest data notice information receiving means KC11D receives latest data notice information indicating that the symbol image data stored in the terminal-side symbol image data storage means are the latest data. Here, the symbol image data transmission request information transmitting means KC10B of Example 2 transmits the terminal-side image data identification information in addition to the symbol image data transmission request information and the resolution related information.

Description of the Controller of the Map Data Delivery Server 7

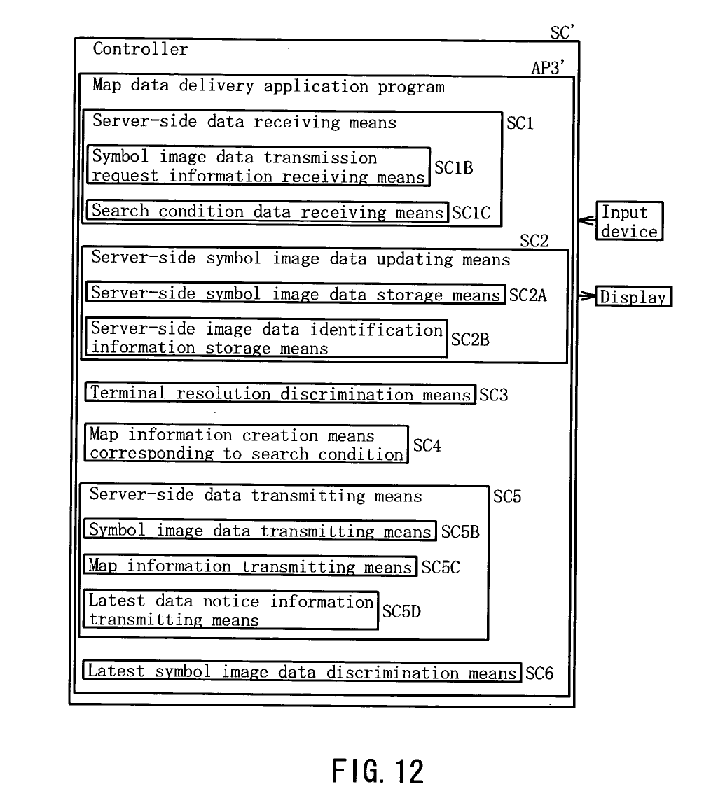

FIG. 12, which corresponds to FIG. 4 of Example 1, is a functional block diagram of the server in the image data transmitting/receiving system of Example 2.

In FIG. 12, in the map data delivery application program AP3′ provided for the controller SC′ of the server 7 of Example 2, the server-side image data identification information transmission request information receiving means SC1A of the server-side data receiving means SC1 is not included in the map data delivery application program AP3 of Example 1. The server-side image data identification information transmitting means SC5A of the server-side data transmitting means SC5 is also likewise excluded.

Further, the map data delivery application program AP3′ of Example 2 includes the latest data notice information transmitting means SC5D of the server-side data transmitting means SC5 and the latest symbol image data discrimination means SC6.

The symbol image data transmission request information receiving means SC1B of Example 2 receives the transmitted symbol image data transmission requests and the resolution related information, as well as the terminal-side image data identification information simultaneously.

SC6: Latest Symbol Image Data Discrimination Means

The latest symbol image data discrimination means SC6 discriminates whether or not the symbol image data stored in the mobile terminal are the latest data on the basis of the terminal-side image data identification information and the server-side image data identification information received.

SC5D: Latest Data Notice Information Transmitting Means

The latest data notice information transmitting means SC5D transmits the latest data notice information that the symbol image data in the mobile phone 1 constitute the latest data to the mobile phone 1 when the symbol image data stored in the mobile phone 1 have been determined as being the latest. In this case, the symbol image data stored in the map data delivery server 7 are not transmitted accordingly.

When the latest symbol image data discrimination means SC6 discriminates that the symbol image data stored in the mobile phone 1 are not the latest, the terminal resolution discrimination means SC3 of Example 2 discriminates the symbol image data transmitted to the mobile phone 1 on the basis of the resolution related information received.

Description of the Flow Chart

Description of the Flow Chart in the Mobile Terminal

The flow chart of processing conducted by the mobile phone 1 of Example 2 will be described hereafter. Here, processing by the mobile phone 1 of Example 2 differs from that of Example 1 in respect of the symbol image data transmitting/receiving processing only. Accordingly, the main flow chart of the map display application program AP1′ corresponds to that of the main flow chart (see FIG. 5) of Example 1, and therefore detailed description thereof will be omitted.

(Symbol Image Data Transmitting/Receiving Processing)

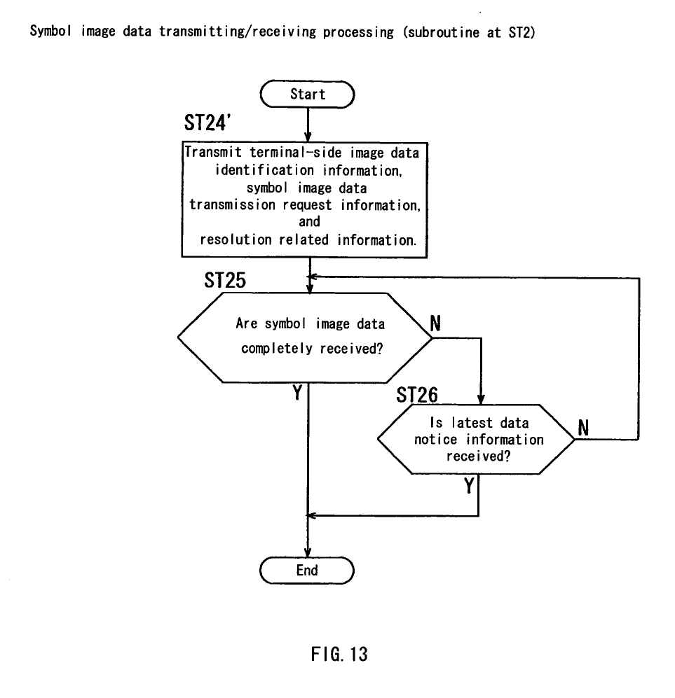

FIG. 13, which corresponds to the flow chart of a subroutine corresponding to FIG. 6 of Example 1, is the flow chart of the symbol image data transmitting/receiving processing conducted by the mobile terminal of Example 2.

ST24′ in FIG. 13 transmits the symbol image data transmission request information, the resolution related information, and the terminal-side image data identification information to the map data delivery server 7 from the mobile phone 1. Thereafter, processing proceeds to ST25.

ST25 discriminates whether the symbol image data transmitted from the server 7 are completely received or not. If No (N), the processing moves to ST26 and if Yes (Y), the symbol image data transmitting/receiving processing shown in FIG. 13 is terminated, reverts to the main flow chart of the map display application program in FIG. 5, and proceeds to the above-mentioned ST3.

ST26 discriminates whether or not the latest data notice information transmitted from the server 7 is received. If No (N), processing reverts to ST25 and if Yes (Y), the symbol image data transmitting/receiving processing shown in FIG. 13 is terminated, reverts to the main flow chart of the map display application program in FIG. 5, and proceeds to ST3.

Description of the Flow Chart in the Server

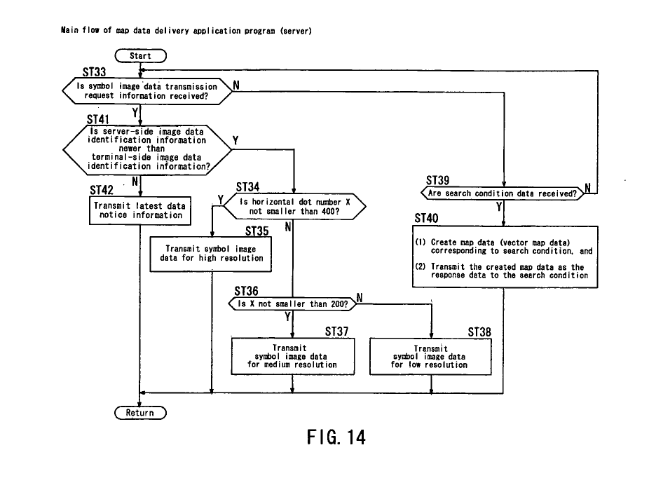

FIG. 14, which corresponds to FIG. 7 of Example 1, is the main flow chart of the map data delivery application program provided for the server in the image data transmitting/receiving system of Example 2.

Next, the main flow chart of the processing executed by the map data delivery server 7 of Example 2 will be described with reference to FIG. 14, in which the same processing steps described Example 1 are accorded similar same ST numbers and detailed description thereof will thus be omitted.

ST33 in FIG. 14 discriminates whether the symbol image data transmission request information is received or not. If Yes (Y), processing proceeds to ST41 and if No (N), processing proceeds to ST39.

ST 41 discriminates whether or not the server-side image data identification information is newer than the terminal-side image data identification information. In particular, ST 41 discriminates whether or not the value of the terminal-side version information is the same as that of the server side. If Yes (Y), (not being the same value), processing proceeds to ST34 and if No (N) (being the same value), processing proceeds to ST42.

If the symbol image data stored in the mobile phone 1 have been determined as being the latest, ST42 transmits the latest data notice information to the mobile phone 1, and processing reverts to ST33.

ST34 through ST38 execute the discrimination processing of the resolution of the information display screen 11 of the mobile phone 1 on the basis of the resolution related information received, in the same manner as that of Example 1, and transmit the symbol image data corresponding to the resolution.

ST39 through ST40 create and transmit the map information (vector map data) in correspondence with the search condition data transmitted from the mobile phone 1 in the same manner as that of Example 1.

Function of Example 2

In the image data transmitting/receiving system S of Example 2 having the above construction, it is the server 7 and not the mobile phone 1 which discriminates whether or not the symbol image data stored in the mobile phone 1 are the latest data. As a result, the processing load of the mobile phone 1 can be reduced while the discrimination processing can be managed entirely by the server 7. In addition, the image data transmitting/receiving system S of Example 2 similarly performs the function of the image data transmitting/receiving system S of Example 1.

### EXAMPLE 3

The image data transmitting/receiving system S of Example 3 of the present invention will be described next. In the description of Example 3, components thereof which correspond to the components of Examples 1 and 2 will be accorded the same symbols, and detailed description thereof will thus be omitted.

Although Example 3 is constructed in the same manner as that of Examples 1 and 2, Example 3 differs from the latter in regard to the following points.

Description of the Controller of the Mobile Phone 1

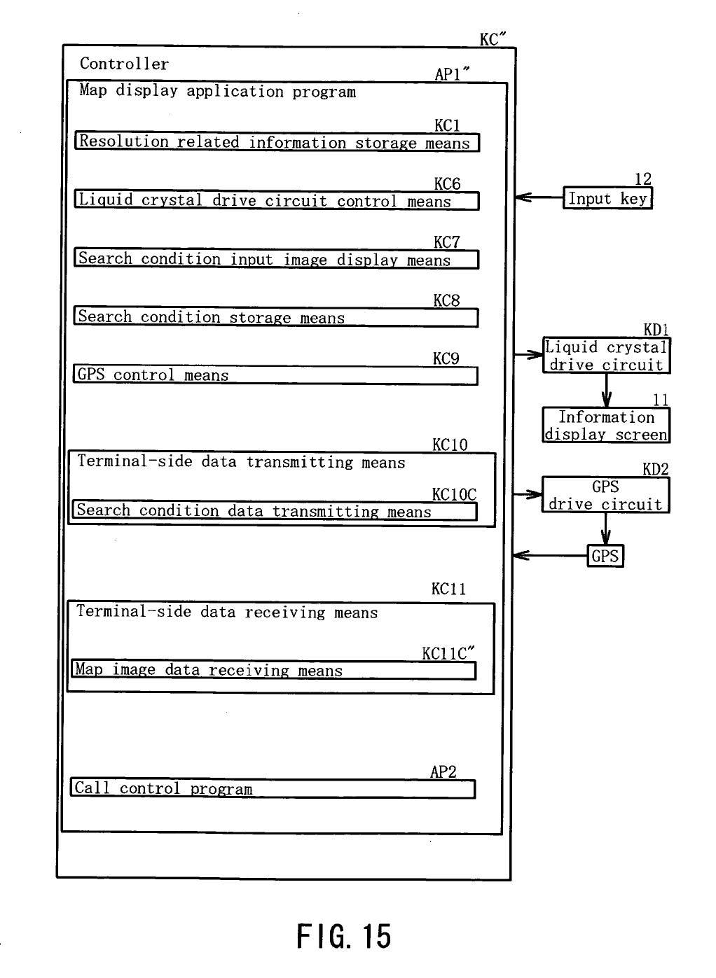

FIG. 15 is a functional block diagram of a mobile terminal in the image data transmitting/receiving system of Example 3, which corresponds to FIG. 2 of Example 1 and FIG. 11 of Example 2.

In FIG. 15, in the map display application program AP1″ provided for the controller KC″ of the mobile phone 1 of Example 3, the following components of the map display application program AP1′ of Example 2 have been excluded: the terminal-side symbol image data storage means KC2, the terminal-side image data identification information storage means KC3, the map image creation means KC5, the symbol image data transmission request information transmitting means KC10B of the terminal-side data transmitting means KC10, the symbol image data receiving means KC10B of the terminal-side data receiving means KC11, and the latest data notice information receiving means KC11D.

Here, in transmitting the search condition data, the search condition data transmitting means (display image data transmission request information transmitting means) KC10C transmits to the server 7, not the map information (vector map data) as in the case of Examples 1 and 2, but the display image data transmission requests to transmit the display images (the so-called raster images, bit map images) arranged on the information display screen and the resolution related information. In correspondence with this, Example 3 includes the map image data receiving means (display image data receiving means) KC11C″ in lieu of the map information receiving means KC11C, and receives the data of display images (raster image data) and not the map information (vector map data).

Description of the Controller of the Map Data Delivery Server 7

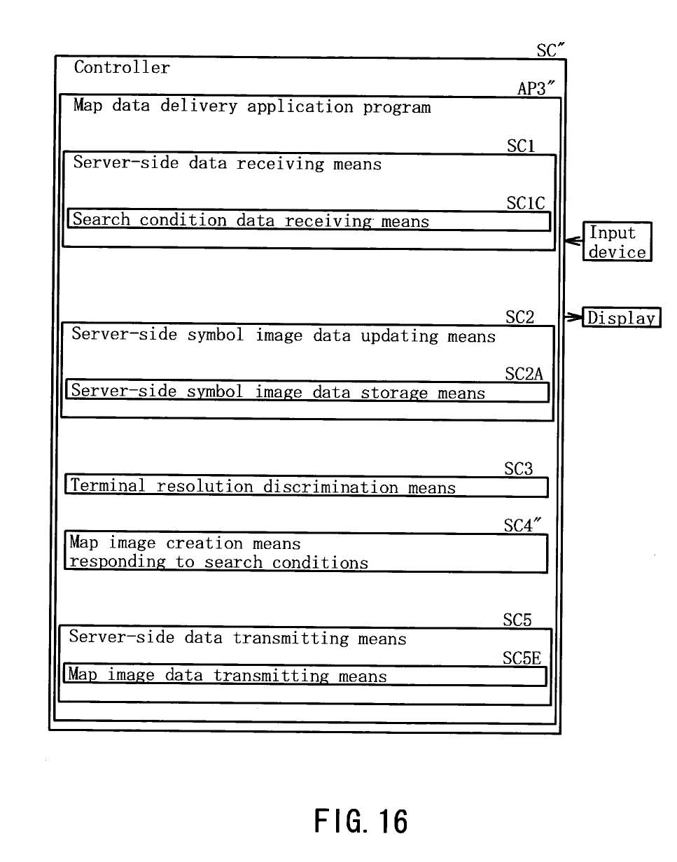

FIG. 16, which corresponds to FIG. 4 of Example 1 and FIG. 12 of Example 2, is a functional block diagram of the server in the image data transmitting/receiving system of Example 3.

In FIG. 16, in the map data delivery application program AP3″ provided for the controller SC″ of the server 7 of Example 3, the symbol image data transmission request information receiving means SC1B of the server-side data receiving means SC1 is excluded from the map data delivery application program AP3′ of Example 2.

The server-side image data identification information storage means SC2B of the server-side symbol image data updating means SC2 is also excluded. Example 3 also includes the display image creation means SC4″ (map image creation means corresponding to the search conditions). Further, the symbol image data transmitting means SC5B, the map information transmitting means SC5C, and the latest data notice information transmitting means SC5D of the server-side data transmitting means SC5 are excluded, while the server-side data transmitting means SC5 is provided with the map image data transmitting means (display image data transmitting means) SC5E. Finally, the search condition data receiving means (display image data transmission request information receiving means) SC1C of Example 3 receives the search condition data transmitted from the mobile phone 1, the display image data transmission request information transmitted with the search condition data, and the resolution related information simultaneously.

SC4″: Map Image Creation Means Responding to Search Conditions (Display Image Creation Means)

The map image creation means responding to the search conditions SC4″ creates the display images (raster map images) arranged on the information display screen 11 of the mobile terminal using the symbol image data which is discriminated by the terminal resolution discrimination means SC3 corresponding to the resolution of the information display screen 11.

SC5E: Map Image Data Transmitting Means (Display Image Data Transmitting Means)

The map image data transmitting means SC5E transmits the display image data constituting the data of the map images (display images) created by the map image creation means responding to search conditions SC4″.

Description of the Main Flow Chart in the Mobile Terminal

Fig., which corresponds to FIG. 5 of Example 1, is a main flow chart of the map display application program provided for the mobile terminal in the image data transmitting/receiving system of Example 3.

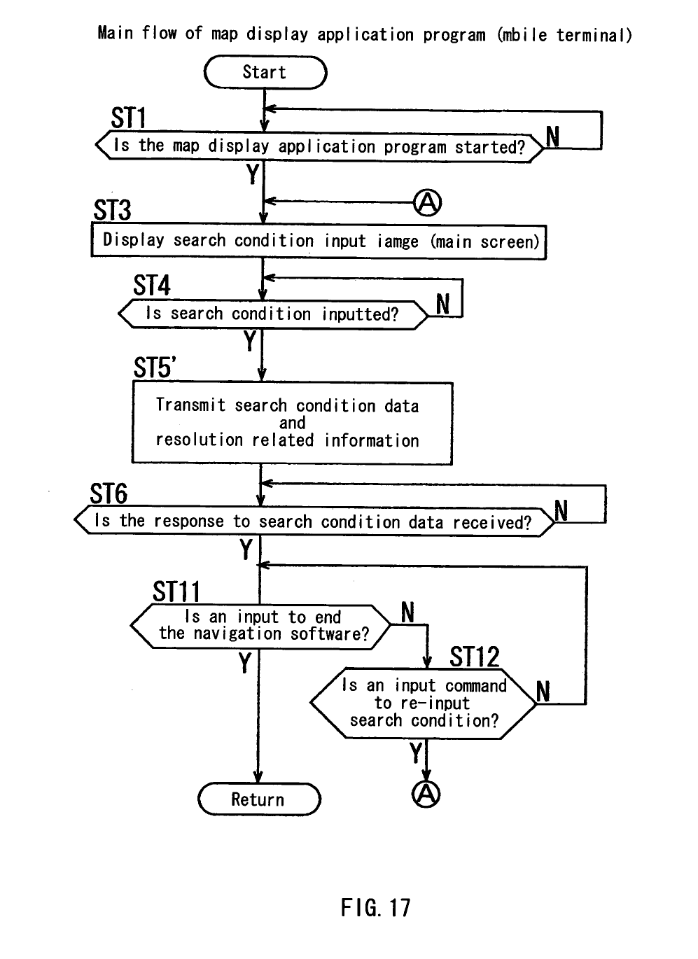

Next, the main flow chart of the processing carried out by the mobile phone 1 of Example 3 will be described with reference to FIG. 17, in which similar processing steps carried out in Example 1 are accorded given the same ST numbers and detailed description thereof will thus be omitted.

In FIG. 17, ST1 discriminates whether the navigation software has been activated or not, in the same manner as ST1 of Example 1. If No (N), ST1 is repeated and if Yes (Y), processing proceeds to ST3, instead of ST2.

ST3, ST4 execute the same processing carried out in ST3, ST4 of Example 1.

ST5′ transmits the search condition data, the display image data transmission request information, and the resolution related information to the server 7. Thereafter, processing proceeds to ST6.

ST6 discriminates whether or not the map image data (raster map image data) are received, constituting the response to the search condition data in the same manner as ST6 of Example 1. If No (N), ST6 is repeated and if Yes (Y), processing proceeds to ST11.

ST11, ST12 execute the same processing carried out in ST11, ST12 of Example 1.

Description of the Flow Chart in the Server

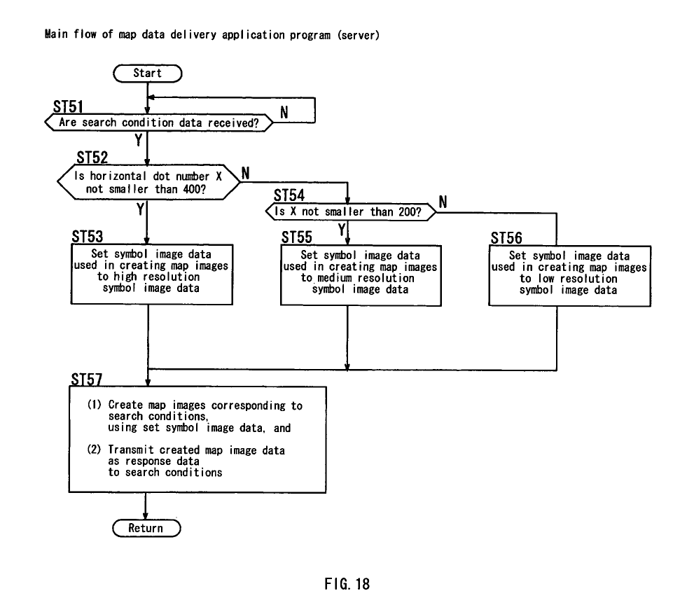

FIG. 18, which corresponds to FIG. 7 of Example 1 and FIG. 14 of Example 2, is a main flow chart of the map data delivery application program provided for the server in the image data transmitting/receiving system of Example 3.

The flow chart illustrated in FIG. 18 starts with the activation of the map data delivery application program in the server 7.

In FIG. 18, ST51 discriminates whether the search condition data transmitted from the mobile phone 1, the display image data transmission request information, and the resolution related information are received or not. If No (N), ST51 is repeated and if Yes (Y), processing proceeds to ST52.

ST52 discriminates whether the value of the horizontal dot number X as representing the resolution related information is equal to or larger than 400. If Yes (Y), processing proceeds to ST53 and if No (N), processing proceeds to ST54.

If the resolution of the information display screen 11 of the mobile phone 1 is indicated as being of high resolution (not smaller than 400 dots), ST53 sets the symbol image data used in creating the map images comprising the high resolution symbol image data, and thereafter, processing proceeds to ST57.

ST54 discriminates whether the value of the horizontal dot number X is equal to or larger than 200. If Yes (Y), processing proceeds to ST55 and if No (N), processing proceeds to ST56.

If the resolution of the information display screen 11 of the mobile phone 1 is indicated as being of medium resolution (200-400 dots), ST55 sets the symbol image data used in creating the map images comprising the medium resolution symbol image data, and thereafter, processing proceeds to ST57.

If the resolution of the information display screen 11 of the mobile phone 1 is indicated as being of low resolution (smaller than 200 dots), ST56 sets the symbol image data used in creating the map images comprising the low resolution symbol image data, and thereafter, processing proceeds to ST57.

In ST57, the following steps (1), (2) take place and thereafter, processing reverts to ST51.
(1) creating the map images (raster map images) corresponding to the received search conditions, using the symbol image data set at any one of ST53, ST55, and ST56.
(2) transmitting the created map image data as the response data to the search conditions, to the mobile phone 1.
   Function of Example 3

In the image data transmitting/receiving system S of Example 3 having the above construction, the display images arranged on the information display screen 11 of the mobile phone 1 are created not by the mobile phone 1, but by the server 7. Here, the symbol image data corresponding to the resolution of the information display screen 11 of the mobile phone 1 are used to create the display images. As a result, it becomes possible to display appropriately sized display images corresponding to the resolution of the information display screen 11 of the mobile phone 1, on the information display screen 11.

Therefore, in the information display screen 11 with high resolution capability, the problem of symbol images becoming excessively small making viewing difficult can be eliminated. Similarly, in the information display screen 11 with low resolution capability, the problem of high resolution symbol images becoming excessively large to be displayed, making viewing of map images (display images) difficult, can also be eliminated. And although the quantity of data in the process of in transmitting/receiving the map images increases, the image data transmitting/receiving system S of Example 3 dispenses with the storage of symbol image data in the mobile phone 1 and updating the data.

The examples given herein are not intended to restrict the scope of the invention, as various changes and modifications are possible without departing from the spirit and scope of the invention and the claims disclosed herein.

For example, it is possible to combine Examples 1 to 3. That is, a mobile phone capable of creating map images from vector map data and a mobile phone capable only of displaying raster map image data may coexist since it is possible for each of them to correspond on the basis of received data. In the same manner, a mobile phone having the means to discriminate whether or not the symbol image data are updated and a mobile phone not having such means may also coexist as it is possible for them to cope individually.

In each of the above examples, the transmitted/received symbol image data are not restricted to the map symbol image data. For example, the image data forming part of the display images displayed on the information display screen 11 such as icon image data constituting the image data of icons (symbols and graphics displaying commands given to computers) may also comprise symbol image data.

Further, the mobile terminal of the present invention is not restricted to the mobile phone, as it is also applicable to a mobile terminal such as a PDA carried by a user.

In each of the above examples, the symbol image data consist of three types, namely: high resolution, medium resolution, and low resolution. However, it is possible to use two types, such as symbol data of high resolution and low resolution, or more than four types of symbol image data in correspondence with the resolution related information.

Further, application of the invention is not restricted to navigation (route guidance) software, as it is also applicable to software for displaying maps, software for creating images displayed on the information display screen 11 using the symbol image data, and so forth.

In Examples 1 and 2, a determination is made on whether the symbol image data stored in the mobile phone 1 are the latest data, and it is only when such data is determined as not being the latest that the symbol image data are transmitted/received. However, it is also possible to construct the system in a manner so that the function of discriminating whether the symbol image data are the latest is not executed, and that the symbol image data corresponding to the resolution be transmitted/received. That is, in Example 1, it is possible to transmit the symbol image data transmission requests and the resolution related information without transmitting or receiving the server-side image data identification information, and to receive the symbol image data corresponding to the resolution. And, in Example 2, it is possible to construct the server that receives the symbol image data transmission requests, so that the symbol image data corresponding to the resolution related information are transmitted without discrimination being made as to whether they are the latest data. In such event, the latest data notice information will not be transmitted or received.

1. An image data transmitting/receiving system comprising a mobile phone terminal provided with the following components (A1) through (A5) and a server provided with the following components (B1) through (B4):
(A1) an information display screen on which information is displayed,
(A2) a resolution related information storage means that stores resolution related information pertinent to the resolution of the information display screen,
(A3) a terminal-side symbol image data storage means that stores symbol image data which are used in creating display images partly constituting specific graphic symbols and arranged on the information display screen,
(A4) a symbol image data transmission request information transmitting means that transmits symbol image data transmission requests for the transmission of symbol image data stored in the server and the resolution related information to the server,
(A5) a symbol image data receiving means that receives the symbol image data transmitted from the server,
(B1) a server-side symbol image data storage means that stores the symbol image data in correspondence with the resolution of the information display screen of the mobile phone terminal,
(B2) a symbol image data transmission request information receiving means that receives the symbol image data transmission request information and the resolution related information, which are transmitted from the mobile phone terminal,
(B3) a terminal resolution discrimination means that discriminates the symbol image data transmitted to the mobile phone terminal on the basis of the resolution related information received, and
(B4) a symbol image data transmitting means that transmits the symbol image data which is discriminated by the terminal resolution discrimination means in correspondence with the resolution of the information display screen of the mobile phone terminal.

2. An image data transmitting/receiving system according to claim 1, comprising the mobile phone terminal provided with the following components (A6) through (A10) and the server provided with the following components (B5) through (B7):
(A6) a terminal-side image data identification information storage means that stores the terminal-side image data identification information constituting identification information of the symbol image data stored in the terminal-side symbol image data storage means,
(A7) an identification information transmission request information transmitting means that transmits server-side image data identification information transmission requests for the server to transmit server-side image data identification information constituting identification information of the symbol image data stored in the server, before creating images displayed on the information display screen,
(A8) a server-side image data identification information receiving means that receives the server-side image data identification information transmitted from the server,
(A9) a latest symbol image data discrimination means that discriminates whether the symbol image data stored in the mobile phone terminal are the latest data, on the basis of the server-side image data identification information and the terminal-side image data identification information received,
(A10) the symbol image data transmission request information transmitting means that transmits the symbol image data transmission request information and the resolution related information to the server, when the symbol image data stored in the mobile phone terminal are determined as not being the latest data,
(B5) a server-side image data identification information storage means that stores the server-side image data identification information constituting identification information of the symbol image data stored in the server-side symbol image data storage means,
(B6) a server-side image data identification information transmission request information receiving means that receives the server-side image data identification information transmission requests transmitted from the mobile phone terminal, and
(B7) a server-side image data identification information transmitting means that transmits the server-side image data identification information upon receiving the server-side image data identification information transmission request.

3. An image data transmitting/receiving system according to claim 1, comprising the mobile phone terminal provided with the following components (A6), (A11), and (A12), and the server provided with the following components (B5), and (B8) through (B11):
(A6) a terminal-side image data identification information storage means that stores terminal-side image data identification information constituting identification information of the symbol image data stored in the terminal-side symbol image data storage means,
(A11) the symbol image data transmission request information transmitting means that transmits, before creating images displayed on the information display screen, the symbol image data transmission requests, the resolution related information, and the terminal-side image data identification information to the server,
(A12) a latest data notice information receiving means that receives notice of information on latest data indicating that the symbol image data stored in the terminal-side symbol image data storage means are the latest data,
(B5) a server-side image data identification information storage means that stores server-side image data identification information constituting identification information of the symbol image data stored in the server-side symbol image data storage means,
(B8) the symbol image data transmission request information receiving means that receives the symbol image data transmission requests, the resolution related information, and the terminal-side image data identification information, which are transmitted from the mobile phone terminal,
(B9) a latest symbol image data discrimination means that discriminates whether the symbol image data stored in the mobile phone terminal are the latest data, on the basis of the terminal-side image data identification information and the server-side image data identification information received,
(B10) a latest data notice information transmitting means that transmits the notice of information on latest data and does not transmit the symbol image data stored in the server to the mobile phone terminal, when it is determined that the symbol image data stored in the mobile phone terminal are the latest data, and
(B11) the terminal resolution discrimination means that discriminates the transmitted symbol image data on the basis of the resolution related information received, when the symbol image data stored in the mobile phone terminal is determined as not being the latest data.

4. An image data transmitting/receiving system according to claim 1, comprising the server provided with the following component (B12) and the mobile phone terminal provided with the following components (A13) and (A14):
(B12) a map information transmitting means that transmits to the mobile phone terminal, map information including symbol image specifying information that specifies the symbol images and location information that specifies locations where the specified symbol images are laid out,
(A13) a map information receiving means that receives the map information transmitted from the server, and
(A14) a map image creation means that creates map images as the display images arranged on the information display screen, on the basis of map information and the symbol image data of the symbol images as map symbol images.

5. An image data transmitting/receiving system comprising a mobile phone terminal provided with the following components (C1) through (C4) and a server provided with the following components (D1) through (D5):
(C1) an information display screen on which information is displayed,
(C2) a resolution related information storage means that stores resolution related information pertinent to the resolution of the information display screen,
(C3) a display image data transmission request information transmitting means that transmits display image data transmission requests for transmission of the display images arranged on the information display screen and the resolution related information to the server,
(C4) a display image data receiving means that receives display image data transmitted from the server,
(D1) a server-side symbol image data storage means that stores symbol image data in correspondence with the resolution of the information display screen of the mobile phone terminal, which are used to create the display images partly constituting the symbol images constituting specific graphic symbols,
(D2) a display image data transmission request information receiving means that receives the display image data transmission requests and the resolution related information, which are transmitted from the mobile phone terminal,
(D3) a terminal resolution discrimination means that discriminates the symbol image data in correspondence with the resolution of the information display screen, on the basis of the resolution related information received,
(D4) a display image creation means that creates the display images arranged on the information display screen of the mobile phone terminal, using the symbol image data which is discriminated by the terminal resolution discrimination means, in correspondence with the resolution of the information display screen, and
(D5) a display image data transmitting means that transmits the display image data constituting the data of created display images.

6. A server capable of transmitting to and receiving image data from a mobile phone terminal comprising:
an information display screen on which information is displayed,
a resolution related information storage means that stores resolution related information pertinent to the resolution of the information display screen,
a terminal-side symbol image data storage means that stores symbol image data, which are used in creating display images partly constituting specific graphic symbols to be arranged on the information display screen, which represent symbol images,
a symbol image data transmission request information transmitting means that transmits symbol image data transmission requests for the transmission of the symbol image data stored in the server and the resolution related information to the server, and
a symbol image data receiving means that receives the symbol image data transmitted from the server,
wherein the server comprises the following components (B1) through (B4):
(B1) a server-side symbol image data storage means that stores the symbol image data in correspondence with the resolution of the information display screen of the mobile phone terminal,
(B2) a symbol image data transmission request information receiving means that receives the symbol image data transmission requests and the resolution related information which are transmitted from the mobile phone terminal,
(B3) a terminal resolution discrimination means that discriminates the symbol image data transmitted to the mobile phone terminal on the basis of the resolution related information received, and
(B4) a symbol image data transmitting means that transmits the symbol image data which is discriminated by the terminal resolution discrimination means in correspondence with the resolution of the information display screen of the mobile phone terminal.

7. A server according to claim 6, capable of transmitting to and receiving image data from a mobile phone terminal comprising:
a terminal-side image data identification information storage means that stores terminal-side image data identification information constituting identification information of the symbol image data stored in the terminal-side symbol image data storage means,
an identification information transmission request information transmitting means that transmits server-side image data identification information transmission requests for the server to transmit server-side image data identification information constituting identification information of the symbol image data stored in the server, before creating images displayed on the information display screen,
a server-side image data identification information receiving means that receives the server-side image data identification information transmitted from the server,
a latest symbol image data discrimination means that discriminates whether the symbol image data stored in the mobile phone terminal are the latest data, on the basis of the server-side image data identification information and the terminal-side image data identification information received, and
the symbol image data transmission request information transmitting means that transmits the symbol image data transmission request information and the resolution related information to the server when the symbol image data stored in the mobile phone terminal are determined as not being the latest data,
wherein the server comprises the following components (B5) through (B7):
(B5) a server-side image data identification information storage means that stores the server-side image data identification information constituting identification information of the symbol image data stored in the server-side symbol image data storage means,
(B6) a server-side image data identification information transmission request information receiving means that receives the server-side image data identification information transmission requests transmitted from the mobile phone terminal, and
(B7) a server-side image data identification information transmitting means that transmits the server-side image data identification information, upon receiving the server-side image data identification information transmission requests.

8. A server according to claim 6, capable of transmitting to and receiving image data from a mobile phone terminal comprising:
a terminal-side image data identification information storage means that stores terminal-side image data identification information constituting identification information of the symbol image data stored in the terminal-side symbol image data storage means,
the symbol image data transmission request information transmitting means that transmits the symbol image data transmission requests, the resolution related information, and the terminal-side image data identification information to the server, before creating images displayed on the information display screen, and
a latest data notice information receiving means that receives notice of information on the latest data indicating that the symbol image data stored in the terminal-side symbol image data storage means are the latest data,
wherein the server comprises the following components (B5), and (B8) through (B11):
(B5) a server-side image data identification information storage means that stores server-side image data identification information constituting identification information of the symbol image data stored in the server-side symbol image data storage means,
(B8) the symbol image data transmission request information receiving means that receives the symbol image data transmission requests, the resolution related information, and the terminal-side image data identification information which are transmitted from a mobile phone terminal,
(B9) a latest symbol image data discrimination means that discriminates whether the symbol image data stored in the mobile phone terminal are the latest data, on the basis of the terminal-side image data identification information and the server-side image data identification information received,
(B10) a latest data notice information transmitting means that transmits the notice of information on the latest data and does not transmit the symbol image data stored in the server to the mobile phone terminal, when it is determined that the symbol image data stored in the mobile phone terminal are the latest data, and
(B11) the terminal resolution discrimination means that discriminates the transmitted symbol image data on the basis of the resolution related information received, when it is determined that the symbol image data stored in the mobile phone terminal are not the latest data.

9. A mobile phone terminal capable of transmitting to and receiving image data from a server comprising:
a server-side symbol image data storage means that stores symbol image data which are used in creating display images partly constituting specific graphic symbols arranged on the information display screen of the mobile phone terminal in correspondence with the resolution of the information display screen,
a symbol image data transmission request information receiving means that receives symbol image data transmission requests to transmit the symbol image data stored in the server and resolution related information pertinent to the resolution of the information display screen,
a terminal resolution discrimination means that discriminates the symbol image data transmitted to the mobile phone terminal on the basis of the resolution related information received, and
a symbol image data transmitting means that transmits the symbol image data which is discriminated by the terminal resolution discrimination means, in correspondence with the resolution of the information display screen of the mobile phone terminal,
wherein the mobile phone terminal comprises the following components (A1) through (A5):
(A1) the information display screen,
(A2) a resolution related information storage means that stores the resolution related information,
(A3) a terminal-side symbol image data storage means that stores the symbol image data,
(A4) a symbol image data transmission request information transmitting means that transmits the symbol image data transmission requests and the resolution related information, and
(A5) a symbol image data receiving means that receives the symbol image data transmitted from the server.

10. A mobile phone terminal according to claim 9, capable of transmitting to and receiving image data from a server comprising:
a server-side image data identification information storage means that stores server-side image data identification information constituting identification information of the symbol image data stored in the server-side symbol image data storage means,
a server-side image data identification information transmission request information receiving means that receives server-side image data identification information transmission requests transmitted from the mobile phone terminal for transmission of the server-side image data identification information, and
a server-side image data identification information transmitting means that transmits the server-side image data identification information upon receiving the server-side image data identification information transmission request,
wherein the mobile phone terminal comprises the following components (A6) through (A10):
(A6) a terminal-side image data identification information storage means that stores terminal-side image data identification information constituting identification information of the symbol image data stored in the terminal-side symbol image data storage means,
(A7) an identification information transmission request information transmitting means that transmits the server-side image data identification information transmission requests to the server, before creating images displayed on the information display screen,
(A8) a server-side image data identification information receiving means that receives the server-side image data identification information transmitted from the server,
(A9) a latest symbol image data discrimination means that discriminates whether the symbol image data stored in the mobile phone terminal are the latest data, on the basis of the server-side image data identification information and the terminal-side image data identification information received, and
(A10) the symbol image data transmission request information transmitting means that transmits the symbol image data transmission request information and the resolution related information to the server, when the symbol image data stored in the mobile phone terminal are determined as not being the latest data.

11. A mobile phone terminal according to claim 9, capable of transmitting to and receiving image data from a server comprising:
a server-side image data identification information storage means that stores server-side image data identification information constituting identification information of the symbol image data stored in the server-side symbol image data storage means,
the symbol image data transmission request information receiving means that receives the symbol image data transmission requests, the resolution related information, and the terminal-side image data identification information constituting identification information of the symbol image data stored in the terminal-side symbol image data storage means, which are transmitted from the mobile phone terminal,
a latest symbol image data discrimination means that discriminates whether the symbol image data stored in the mobile phone terminal are the latest data, on the basis of the terminal-side image data identification information and the server-side image data identification information received,
a latest data notice information transmitting means that transmits notice of information on the latest data indicating that the symbol image data stored in the terminal-side symbol image data storage means are the latest and does not transmit the symbol image data stored in the server to the mobile phone terminal, when the symbol image data stored in the mobile phone terminal are determined as being the latest, and
the terminal resolution discrimination means that discriminates the transmitted symbol image data on the basis of the resolution related information received, when the symbol image data stored in the mobile phone terminal are determined as not being the latest,
wherein the mobile phone terminal comprises the following components (A6), (A11), and (A12):
(A6) the terminal-side image data identification information storage means that stores the terminal-side image data identification information,
(A11) the symbol image data transmission request information transmitting means that transmits the symbol image data transmission requests, the resolution related information, and the terminal-side image data identification information to the server, before creating images displayed on the information display screen,
(A12) a latest data notice information receiving means that receives notice of information on the latest data indicating that the symbol image data stored in the terminal-side symbol image data storage means are the latest data.

12. A server capable of transmitting to and receiving image data from a mobile phone terminal comprising:
an information display screen on which information is displayed,
a resolution related information storage means that stores resolution related information pertinent to the resolution of the information display screen,
a display image data transmission request information transmitting means that transmits display image data transmission requests for transmission of the display images arranged on the information display screen and the resolution related information to the server, and
a display image data receiving means that receives display image data transmitted from the server,
wherein the server comprises the following components (D1) through (D5):
(D1) a server-side symbol image data storage means that stores symbol image data which are used to create the display images partly constituting specific graphic symbols, in correspondence with the resolution of the information display screen of the mobile phone terminal,
(D2) a display image data transmission request information receiving means that receives the display image data transmission requests and the resolution related information, which are transmitted from the mobile phone terminal,
(D3) a terminal resolution discrimination means that discriminates the symbol image data in correspondence with the resolution of the information display screen, on the basis of the resolution related information received,
(D4) a display image creation means that creates the display images arranged on the information display screen of the mobile phone terminal, using the symbol image data which is discriminated by the terminal resolution discrimination means, in correspondence with the resolution of the information display screen, and
(D5) a display image data transmitting means that transmits display image data constituting the data of created display images.

13. A mobile phone terminal capable of transmitting to and receiving image data from a server comprising:
a server-side symbol image data storage means that stores symbol image data which are used to create the display images partly constituting specific graphic symbols arranged in correspondence with the resolution of the information display screen of the mobile phone terminal,
a display image data transmission request information receiving means that receives display image data transmission requests for transmission of the display images arranged on the information display screen and resolution related information pertinent to the resolution of the information display screen,
a terminal resolution discrimination means that discriminates the symbol image data in correspondence with the resolution of the information display screen, on the basis of the resolution related information received,
a display image creation means that creates the display images arranged on the information display screen of the mobile phone terminal, using the symbol image data which is discriminated by the terminal resolution discrimination means in correspondence with the resolution of the information display screen, and
a display image data transmitting means that transmits display image data constituting the data of created display images,
wherein the mobile phone terminal comprises the following components (C1) through (C4):
(C1) the information display screen on which information is displayed,
(C2) a resolution related information storage means that stores the resolution related information pertinent to the resolution of the information display screen,
(C3) a display image data transmission request information transmitting means that transmits the display image data transmission requests for transmission of the display images arranged on the information display screen and the resolution related information to the server, and
(C4) a display image data receiving means that receives the display image data transmitted from the server.

14. A program that runs on a computer included in a server capable of transmitting to and receiving image data from a mobile phone terminal comprising:
an information display screen on which information is displayed,
a resolution related information storage means that stores resolution related information pertinent to the resolution of the information display screen,
a terminal-side symbol image data storage means that stores symbol image data which are used to create display images partly constituting specific graphic symbols to be arranged on the information display screen,
a symbol image data transmission request information transmitting means that transmits symbol image data transmission requests to transmit the symbol image data stored in the server and the resolution related information to the server, and
a symbol image data receiving means that receives the symbol image data transmitted from the server,
wherein the program causes the computer to function as:
a server-side symbol image data storage means that stores the symbol image data in correspondence with the resolution of the information display screen of the mobile phone terminal,
a symbol image data transmission request information receiving means that receives the symbol image data transmission requests and the resolution related information which are transmitted from the mobile phone terminal,
a terminal resolution discrimination means that discriminates the symbol image data transmitted to the mobile phone terminal on the basis of the resolution related information received, and
a symbol image data transmitting means that transmits the symbol image data which is discriminated by the terminal resolution discrimination means in correspondence with the resolution of the information display screen of the mobile phone terminal.

15. A program according to claim 14, that runs on a computer included in a server capable of transmitting to and receiving image data from a mobile phone terminal comprising:
a terminal-side image data identification information storage means that stores terminal-side image data identification information constituting identification information of the symbol image data stored in the terminal-side symbol image data storage means,
an identification information transmission request information transmitting means that transmits server-side image data identification information transmission requests for the server to transmit server-side image data identification information constituting identification information of the symbol image data stored in the server, before creating images displayed on the information display screen,
a server-side image data identification information receiving means that receives the server-side image data identification information transmitted from the server,
a latest symbol image data discrimination means that discriminates whether the symbol image data stored in the mobile phone terminal are the latest data on the basis of the received server-side image data identification information and the terminal-side image data identification information, and
the symbol image data transmission request information transmitting means that transmits the symbol image data transmission request information and the resolution related information to the server when the symbol image data stored in the mobile phone terminal are determined as not being the latest data,
wherein the program causes the computer to function as:
a server-side image data identification information storage means that stores the server-side image data identification information constituting identification information of the symbol image data stored in the server-side symbol image data storage means,
a server-side image data identification information transmission request information receiving means that receives the server-side image data identification information transmission request information transmitted from the mobile phone terminal, and
a server-side image data identification information transmitting means that transmits the server-side image data identification information, upon receiving the server-side image data identification information transmission requests.

16. A program according to claim 14, that runs on a computer included in a server capable of transmitting to and receiving image data from a mobile phone terminal comprising:
a terminal-side image data identification information storage means that stores terminal-side image data identification information constituting identification information of the symbol image data stored in the terminal-side symbol image data storage means,
the symbol image data transmission request information transmitting means that transmits the symbol image data transmission requests, the resolution related information, and the terminal-side image data identification information to the server, before creating images displayed on the information display screen, and
a latest data notice information receiving means that receives notice of information on the latest data indicating that the symbol image data stored in the terminal-side symbol image data storage means are the latest data,
wherein the program causes the computer to function as:
a server-side image data identification information storage means that stores server-side image data identification information constituting identification information of the symbol image data stored in the server-side symbol image data storage means,
the symbol image data transmission request information receiving means that receives the symbol image data transmission requests, the resolution related information, and the terminal-side image data identification information which are transmitted from the mobile phone terminal,
a latest symbol image data discrimination means that discriminates whether the symbol image data stored in the mobile phone terminal are the latest data, on the basis of the terminal-side image data identification information and the server-side image data identification information received,
a latest data notice information transmitting means that transmits the notice of information on the latest data and does not transmit the symbol image data stored in the server to the mobile phone terminal, when the symbol image data stored in the mobile phone terminal have been determined as being the latest data, and
the terminal resolution discrimination means that discriminates the transmitted symbol image data on the basis of the resolution related information received, when the symbol image data stored in the mobile phone terminal have been determined as not being the latest.

17. A program that runs on a computer included in a mobile phone terminal capable of transmitting to and receiving image data from a server comprising:
a server-side symbol image data storage means that stores symbol image data which are used to create the display images partly constituting specific graphic symbols arranged on the information display screen of the mobile phone terminal in correspondence with the resolution of the information display screen of the mobile phone terminal,
a symbol image data transmission request information receiving means that receives symbol image data transmission requests to transmit the symbol image data stored in the server and resolution related information pertinent to the resolution of the information display screen of the mobile phone terminal,
a terminal resolution discrimination means that discriminates the symbol image data transmitted to the mobile phone terminal on the basis of the resolution related information received, and
a symbol image data transmitting means that transmits the symbol image data which is discriminated by the terminal resolution discrimination means in correspondence with the resolution of the information display screen of the mobile phone terminal,
wherein the program causes the computer to function as:
a resolution related information storage means that stores the resolution related information,
a terminal-side symbol image data storage means that stores the symbol image data,
a symbol image data transmission request information transmitting means that transmits the symbol image data transmission requests and the resolution related information, and
a symbol image data receiving means that receives the symbol image data transmitted from the server.

18. A program according to claim 17, that runs on a computer included in a mobile phone terminal capable of transmitting to and receiving image data from a server comprising:
a server-side image data identification information storage means that stores server-side image data identification information constituting identification information of the symbol image data stored in the server-side symbol image data storage means,
a server-side image data identification information transmission request information receiving means that receives server-side image data identification information transmission requests for transmission of the server-side image data identification information which is transmitted from the mobile phone terminal, and
a server-side image data identification information transmitting means that transmits the server-side image data identification information, upon receiving the server-side image data identification information transmission request information,
wherein the program causes the computer to function as:
a terminal-side image data identification information storage means that stores terminal-side image data identification information constituting identification information of the symbol image data stored in the terminal-side symbol image data storage means,
an identification information transmission request information transmitting means that transmits the server-side image data identification information transmission requests to the server, before creating images displayed on the information display screen,
a server-side image data identification information receiving means that receives the server-side image data identification information transmitted from the server,
a latest symbol image data discrimination means that discriminates whether the symbol image data stored in the mobile phone terminal are the latest data, on the basis of the server-side image data identification information and the terminal-side image data identification information received, and
the symbol image data transmission request information transmitting means that transmits the symbol image data transmission request information and the resolution related information to the server, when the symbol image data stored in the mobile phone terminal have been determined as not being the latest.

19. A program according to claim 17, that runs on a computer included in a mobile phone terminal capable of transmitting to and receiving image data from a server comprising:
a server-side image data identification information storage means that stores server-side image data identification information constituting identification information of the symbol image data stored in the server-side symbol image data storage means,
the symbol image data transmission request information receiving means that receives the symbol image data transmission requests, the resolution related information, and the terminal-side image data identification information constituting identification information of the symbol image data stored in the terminal-side symbol image data storage means which are transmitted from the mobile phone terminal,
a latest symbol image data discrimination means that discriminates whether the symbol image data stored in the mobile phone terminal are the latest data, on the basis of the terminal-side image data identification information and the server-side image data identification information received,
a latest data notice information transmitting means that transmits notice of information on the latest data indicating that the symbol image data stored in the terminal-side symbol image data storage means are the latest and does not transmit the symbol image data stored in the server to the mobile phone terminal, when the symbol image data stored in the mobile phone terminal have been determined as being the latest data, and
the terminal resolution discrimination means that discriminates the transmitted symbol image data on the basis of the resolution related information received, when the symbol image data stored in the mobile phone terminal have been determined as not being the latest.
wherein the program causes the computer to function as:
a terminal-side image data identification information storage means that stores the terminal-side image data identification information,
the symbol image data transmission request information transmitting means that transmits the symbol image data transmission requests, the resolution related information, and the terminal-side image data identification information to the server, before creating images displayed on the information display screen, and
a latest data notice information receiving means that receives notice of information on the latest data indicating that the symbol image data stored in the terminal-side symbol image data storage means are the latest data.

20. A program that runs on a computer included in a server capable of transmitting to and receiving image data from a mobile phone terminal comprising:
an information display screen on which information is displayed,
a resolution related information storage means that stores resolution related information pertinent to the resolution of the information display screen,
a display image data transmission request information transmitting means that transmits display image data transmission requests to transmit display images arranged on the information display screen and the resolution related information to the server, and
a display image data receiving means that receives display image data transmitted from the server,
wherein the program causes the computer to function as:
a server-side symbol image data storage means that stores the symbol image data which are used to create the display images partly constituting specific graphic symbols, in correspondence with the resolution of the information display screen of the mobile phone terminal,
a display image data transmission request information receiving means that receives the display image data transmission requests and the resolution related information which are transmitted from the mobile phone terminal,
a terminal resolution discrimination means that discriminates the symbol image data in correspondence with the resolution of the information display screen of the mobile phone terminal on the basis of the received resolution related information,
a display image creation means that creates the display images arranged on the information display screen of the mobile phone terminal, using the symbol image data which is discriminated by the terminal resolution discrimination means in correspondence with the resolution of the information display screen of the mobile phone terminal, and
a display image data transmitting means that transmits the display image data constituting the data of created display images.

21. A program that runs on a computer included in a mobile phone terminal capable of transmitting to and receiving image data from a server comprising:
a server-side symbol image data storage means that stores symbol image data which are used in creating display images partly constituting specific graphic symbols arranged on the information display screen of the mobile phone terminal,
a display image data transmission request information receiving means that receives display image data transmission requests to transmit the display images arranged on the information display screen, and the resolution related information pertinent to the resolution of the information display screen of the mobile phone terminal,
a terminal resolution discrimination means that discriminates the symbol image data in correspondence with the resolution of the information display screen of the mobile phone terminal, on the basis of the resolution related information received,
a display image creation means that creates the display images arranged on the information display screen of the mobile phone terminal, using the symbol image data which is discriminated by the terminal resolution discrimination means in correspondence with the resolution of the information display screen of the mobile phone terminal, and
a display image data transmitting means that transmits display image data constituting the data of created display images,
wherein the program causes the computer to function as:
a resolution related information storage means that stores resolution related information pertinent to the resolution of the information display screen on which information is displayed,
a display image data transmission request information transmitting means that transmits display image data transmission requests to transmit the display images arranged on the information display screen and the resolution related information to the server, and
a display image data receiving means that receives the display image data transmitted from the server.

22. A computer-readable recording medium in which any of the programs according to claim 14 is recorded.
